(19) United States
(12) Patent Application Publication
(10) Pub. No.: US 2006/0147847 A1
(43) Pub. Date: Jul. 6, 2006

(54) Antimicrobial compositions and methods

(76) Inventors: Patrick E. Guire, Eden Prairie, MN (US); Kristin S. Taton, Little Canada, MN (US); Jie Wen, Eden Prairie, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/027,036

(22) Filed: Dec. 30, 2004

(51) Int. Cl. G03C 5/00

(52) U.S. Cl. 430/323

(57) ABSTRACT

The invention provides polymeric reagents of a formula:
Xₐ—Y-Z_{b} wherein X is a latent reactive group, Y is a polymeric backbone, and Z is a melamine group. In some aspects of the above formula, a is in the range of 0.5 to 90 mole percent, and b is in the range of 10 to 99.5 mole percent. The latent reactive group can be a photoreactive group or a thermally-reactive group. Monomeric units for preparing the polymeric reagents are also described. Methods of using the polymeric reagents to provide modified surfaces are also described, as well as methods of providing biocidal surfaces and methods of treating habitats for halogen-sensitive microorganisms.

### FIELD OF THE INVENTION

The invention relates to novel polymeric reagents that have biocidal activity against an array of microorganisms. These polymeric reagents include a polymeric backbone, latent reactive groups, and cyclic amine groups. The cyclic amine groups are capable of being halogenated and thereby can provide biocidal function when they contact halogen-sensitive organisms. The polymeric reagent compositions can be provided in the form of coatings on surfaces, thereby providing surfaces with biocidal activity.

### BACKGROUND OF THE INVENTION

Microorganisms occur naturally in potable and recreational waters, as well as in hot water systems, cooling towers, and public water structures such as decorative fountains. These microorganisms may be protozoa, bacteria, or viruses and may be pathogenic.

Waterborne pathogens can pose a significant health risk, particularly when the water may be ingested. Proper disinfection of water is important, since waters are continually inoculated with microorganisms that are naturally occurring or can be introduced into a water system. Disinfection of many water systems has traditionally been performed by chlorine and chlorine compounds; bromine compounds are gaining acceptance for some disinfection uses.

Chlorine has a rapid inactivation rate for most microorganisms and is sufficiently long-lived to provide a protective residual for continued disinfection. Further, chlorine is relatively inexpensive and readily available. However, there exist number of drawbacks associated with use of aqueous chlorine as a disinfectant. For example, inefficient side reactions can occur when aqueous chlorine is used, and some of the reaction products are presently considered potentially hazardous. Moreover, the chlorine residual has a relatively short lifetime and must be continually monitored to maintain a free chlorine residual in a desired range. If the chlorine levels drop below certain levels for a period of time, bacteria can attach to surfaces to form biofilms. Once a biofilm has formed, the bacteria of the biofilm are highly resistant to disinfection and removal from the surface.

Recent attention has been given to N-halamines, a class of chemicals that contain chlorine bound to a nitrogen atom, wherein the nitrogen atom is a member of a ring, along with carbon atoms. When bound to nitrogen in this way, the chlorine is in a stable form, giving it the capability of staying in place and retaining the ability to interact with targets on the surfaces of bacteria and other microbes. When it does this it damages those targets. By virtue of the use of chlorine, N-halamines have a broad spectrum of action against all microorganisms because they target the cell membrane. Moreover, N-halamines are efficacious against a full array of bacteria and yet are safe for humans.

### SUMMARY OF THE INVENTION

Generally, the invention provides polymeric reagent compositions adapted to be modified to include halamine groups. In some aspects, the inventive reagents are adapted to be provided to a support surface in order to provide that surface with halamine groups. The surface, thus treated, can be used for any suitable purpose, and is particularly well suited for use as a treatment for water lines where it is desirable to minimize or eliminate the formation of biofilms along the interior surface of the water lines.

In accordance with the invention, the polymeric reagent compositions are provided in the form of polymeric reagents adapted to be coated onto a support surface via stable covalent bonds in order to provide the surface with biocidal function. Generally speaking, the polymeric reagents include latent reactive groups and cyclic amine groups, wherein each of the latent reactive groups and cyclic amine groups are attached to a polymeric backbone. The latent reactive groups are adapted to bind the polymeric reagent to a surface, and the cyclic amine groups are adapted to be activated by a suitable composition, to provide halamine groups.

Thus, in some aspects, the invention provides polymeric reagents having the general formula:
X_{a—Y-Z}_{b}
wherein X is a latent reactive group, Y is a polymeric backbone, and Z is a cyclic amine group.

In some aspects, a is in the range of about 0.5 to about 90 mole percent, or in the range of about 0.5 to about 30 mole percent; and b is in the range of about 10 to about 99.5 mole percent, or in the range of about 10 to about 50 mole percent.

The latent reactive group can comprise a photoreactive group or thermally-reactive group. The cyclic amine group is a 4- to 7-membered heterocyclic ring in which the members of the ring comprise three or more carbon atoms, one to three nitrogen heteroatoms, and zero to one oxygen heteroatoms. Optionally, some of the carbon atoms of the cyclic amine can comprise carbonyl groups. The cyclic amine group is selected to undergo activation with a source of free halogen, whereby a nitrogen atom (whether the nitrogen atom is a member of the ring or an amine pendent from the ring) is halogenated to thereby provide a cyclic halamine group.

In preferred embodiments, the polymeric reagent composition comprises a polymeric backbone, a melamine group attached to the polymeric backbone, and a latent reactive group attached to the polymeric backbone. The latent reactive group of the polymeric reagent is a photoreactive group or a thermally-reactive group. Upon halogenation, one or more of the nitrogen atoms of an amine group pendent from the melamine ring (a nitrogen atom that is not a member of the heterocycle) is joined to a halogen, such as chlorine or bromine. The latent reactive group binds the polymeric reagent to a surface of interest, and the melamine group, upon halogenation, provides halamine groups. The resulting surface has biocidal properties.

In other aspects, the invention provides reagent compositions comprising monomeric units that can be polymerized to form polymeric reagents that include latent reactive groups and cyclic amine groups. Illustrative monomeric units have the following structure: 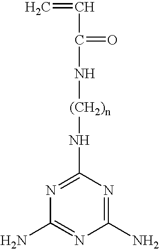
wherein n is 2 to 4.

In other aspects, the invention provides methods for modifying a surface, the methods including steps of providing a polymeric reagent composition, the polymeric reagent composition comprising a polymeric backbone having pendent latent reactive groups, and pendent cyclic amine groups, to a surface, and binding the polymeric reagent to the surface. The polymeric reagent is bound to the surface via the latent reactive groups, which comprise photoreactive groups or thermally-reactive groups.

In other aspects, the invention provides methods for providing halamine groups on a surface, the method including steps of binding a polymeric reagent composition to the surface, the polymeric reagent composition comprising a polymeric backbone having pendent latent reactive groups and pendent cyclic amine groups, and activating the polymeric reagent composition to provide halamine groups to the polymeric reagent composition.

Generally, the polymeric reagent will first be bound to a surface by activation of latent reactive groups, and thereafter the polymeric reagent is contacted with a free halogen compound to halogenate the polymeric reagent. The resulting halogenated surface provides biocidal properties.

In further aspects, the invention provides polymer-coupled supports comprising a polymeric reagent comprising a polymeric backbone, latent reactive groups attached to the polymeric backbone, and cyclic amine groups attached to the polymeric backbone, and a support, wherein the polymeric reagent is bound to the support. Methods of preparing the polymer-coupled supports are also provided.

In other aspects, the invention provides biocidal surfaces comprising a polymeric reagent bound to a surface, the polymeric reagent comprising a polymeric backbone, latent reactive groups attached to the polymeric backbone, and halamine groups attached to the polymeric backbone. The biocidal surfaces are capable of multiple regeneration by exposure of the bound polymeric reagent to a source of free halogen. Methods of preparing the biocidal supports are also provided.

The polymeric reagent compositions described herein can be applied as a coating onto a plurality of substrates. Once the polymeric reagent compositions are bound to a surface and activated by halogenation, the polymeric reagents are useful for their disinfectant properties. The biocidal properties can be regenerated by renewed halogenation in appropriate solutions (such as chlorine or bromine solutions).

A polymeric reagent of the invention can be prepared using any suitable means, such as by the reaction of monomers providing one or more latent reactive groups with one or more reactive comonomers (for example, monomers providing cyclic amine groups) and/or with one or more non-reactive comonomers (for example, “diluent” monomers lacking either a photoreactive group or cyclic amine). Those skilled in the relevant art, given the present description, will appreciate the manner in which a polymer of the invention can be synthesized by free radical polymerization using concentrations and ratios of monomers tailored to achieve the desired surface characteristics. Thus, the relative and absolute concentrations of cyclic amine groups, as well as the molecular weight of the polymer (and extent of branching and the like) and the means of immobilizing the polymer (such as by the numbers and/or locations of latent reactive groups along its length) can all be adjusted to optimize performance.

Comonomers having cyclic amine groups of varying types and reactivities, can be selected as well. Although not the only determining factor, the length of whatever spacer may be included between a cyclic amine and the polymeric backbone can have a predictable or determinable effect on the reactivity of the cyclic amine group. In addition, relatively inert monomers can be included, in effect as diluent monomers, in order to adjust the density of the cyclic amine groups to desired levels and to achieve the desired polymer characteristics (for example, to adjust its hydrophilic, hydrophobic, or amphiphilic nature, which in turn can affect its solvation characteristics).

Finally, comonomers can also be included that provide latent reactive groups for immobilizing the polymer onto a surface. Such monomers preferably contain photoreactive groups or thermally-reactive groups that can be used to either attach the polymeric reagent directly to a corresponding reactive site or group on the surface, or to another reagent that itself provides a photoreactive group. The comonomers can also be selected having different polymerization rates, to optimize the distribution of comonomers in the polymer. Optionally, or in addition, comonomer distribution can be affected by the preparation and use of block copolymers.

The polymeric reagent compositions described herein can be synthesized through two routes. In other aspects, the polymeric reagents are synthesized by copolymerizing selected monomers as discussed above. In some embodiments, vinyl monomers derivatized with latent reactive groups are copolymerized with vinyl monomers derivatized with cyclic amine groups. One preferred vinyl monomer derivatized with a cyclic amine group is an acrylamide having a diamine (C₂-C₆) spacer that attaches a melamine group to the acrylamide. In other aspects, the polymeric reagents are synthesized by conjugating latent reactive groups (photoreactive or thermally-reactive) and cyclic amine groups to a premade polymeric backbone containing amine groups. For example, a polymeric backbone comprising an acrylamide can be subsequently reacted with latent reactive groups and cyclic amine groups to provide a polymeric reagent for use as described herein.

The invention further relates to methods for treating an environment suspected to contain (or become exposed to) undesirable microorganisms, the method including steps of providing the treatment environment with a novel coating compositions comprising a polymeric reagent composition, the polymeric reagent composition comprising a polymeric backbone, a latent reactive group attached to the polymeric backbone, and cyclic amine groups attached to the polymeric backbone, wherein the cyclic amine groups are activated to provide halamine groups.

These and other aspects and advantages will now be described in more detail.

### DETAILED DESCRIPTION OF THE INVENTION

The embodiments of the invention described below are not intended to be exhaustive or to limit the invention to the precise forms disclosed in the following detailed description. Rather, the embodiments are chosen and described so that others skilled in the art can appreciate and understand the principles and practices of the invention.

The invention is directed to polymeric reagent compositions provided in the form of polymeric reagents adapted to be coated onto a support surface via stable covalent bonds in order to provide the surface with biocidal function. Generally speaking, the polymeric reagents include latent reactive groups and cyclic amine groups, wherein each of the latent reactive groups and cyclic amine groups are attached to a polymeric backbone. The latent reactive groups are adapted to bind the polymeric reagent to a surface, and the cyclic amine groups are adapted to be activated by a suitable composition, to provide halamine groups.

Thus, in some aspects, the invention provides polymeric reagent compositions having the general formula:
Xₐ—Y-Z_{b}
wherein X is a latent reactive group, Y is a polymeric backbone, and Z is a cyclic amine group.

In some aspects, for the above formula, a is in the range of about 0.5 to about 90 mole percent, or in the range of about 0.5 to about 30 mole percent; and b is in the range of about 10 to about 99.5 mole percent, or in the range of about 10 to about 50 mole percent.

The latent reactive group can comprise a photoreactive group or thermally-reactive group. The cyclic amine group is a 4- to 7-membered heterocyclic ring in which the members of the ring comprise three or more carbon atoms, one to three nitrogen heteroatoms, and zero to one oxygen heteroatoms. Optionally, some of the carbon atoms of the cyclic amine can comprise carbonyl groups. The cyclic amine group is selected to undergo activation with a source of free halogen, whereby a nitrogen atom (whether the nitrogen atom is a member of the ring or an amine pendent from the ring) is bound to a halogen, to thereby provide a cyclic halamine group. Preferably, the cyclic amine is melamine.

Several benefits can be provided by the inventive reagent compositions. In preferred aspects, the polymeric reagent compositions provide a stable coating on a surface through the use of photoreactive or thermally-reactive groups to bind the reagent to the surface. Preferably, the inventive polymeric reagents provide stable, consistent coatings on a variety of surfaces. Consistency of coating, while not critical for antimicrobial effect in a treatment habitat, can be beneficial for a number of reasons, as will be described herein. In some aspects, the cyclic amine group comprises melamine, which is a commonly available and inexpensive compound. In these aspects, then, an efficient and cost-effective manner of making biocidal reagents has been provided. In other aspects, the invention can provide sustainable release of halogen (such as chlorine or bromine) to a treatment environment. In some preferred aspects, the inventive methods and compositions provide halamine sources that can be regenerated multiple times, such that the biocidal compositions and surfaces provide a long-term biocidal function.

In its method aspects, the invention provides methods for modifying a surface, the methods including steps of providing a polymeric reagent composition, the polymeric reagent composition comprising a polymeric backbone, latent reactive groups, and cyclic amine groups, to a surface, and binding the polymeric reagent to the surface. The cyclic amine groups comprise 4- to 7-membered heterocyclic rings in which the members of the ring comprise three or more carbon atoms, one to three nitrogen heteroatoms, and zero to one oxygen heteroatoms. Optionally, some of the carbon atoms of the cyclic amine can comprise carbonyl groups. The cyclic amine group can be subsequently activated by exposure to a source of free halogen, as described herein. The activated polymeric reagent can thus provide biocidal function to the surface to which it is bound.

Several benefits can be provided by the inventive methods described herein. The use of latent reactive groups (photoreactive or thermally-reactive) provides stable methods of binding the polymeric reagent to the surface. The photoreactive and thermally-reactive groups participate in reactions by which hydrogen atoms are abstracted from the surface, thereby forming stable bonds between the polymeric reagent and the surface. Thus, the polymeric reagents can be applied to a wide variety of surface materials. This enables application of the polymeric reagents to existing surfaces within a treatment environment, as opposed to providing a separate component (such as a filter device) to the treatment environment.

The latent reactive groups provide significant flexibility in terms of coating methods, since the polymeric reagent is bound to a surface by providing an appropriate energy source to the polymeric reagent at the surface. For example, when the latent reactive groups comprise photoreactive groups, a source of light of suitable wavelength is provided to bind the polymeric reagent to the surface. When the latent reactive groups comprise thermally-reactive groups, the polymeric reagent is applied to the surface, and the surface is heated, thereby binding the polymeric reagent to the surface. The inventive methods thus allow the polymeric reagents to be applied to surfaces composed of a wide variety of materials and used in a wide variety of applications. This can be particularly beneficial, for example, when it is desirable to apply a biocidal coating within an interior opaque environment, such as interior surfaces of devices or equipment. One illustrative example is in the dental field, where water supply tubing is contained within larger, more complex equipment. The inventive methods allow the polymeric reagent to be provided in solution to the tubing, and the appropriate energy source provided to bind the reagent to the surface (for example, simple heating). As a result, the coating methods do not require dismantling of the equipment to access the interior components and surfaces.

Several terms will be used throughout the specification.

A “treatment environment” refers to an environment that is exposed to the polymeric reagent compositions and modified surfaces described herein. The treatment environment is typically a habitat exposed (or suspected to be exposed) to undesirable microorganisms, such as undesirable bacteria, viruses, fungi, protozoa, or the like. The treatment environment is one in which such microorganisms are capable of survival for any period of time. Illustrative treatment environments include water supply systems, including storage and treatment tanks, conduits (tubes), filters, and the like. Other treatment environments are described herein. Typical treatment environments include habitats for halogen-sensitive microorganisms.

“Polymer” refers to a compound having one or more of the same or different repeating monomeric units and includes linear homopolymers and copolymers, branched homopolymers and copolymers, graft homopolymers and copolymers, and the like. Polymers are typically formed by polymerization of monomers having polymerizable groups. A polymer therefore includes monomeric units and has a “polymeric backbone” formed by the “polymeric linkages,” which are covalent bonds formed between monomeric units during polymerization. The polymeric backbone is typically the polymer without the addition of the cyclic amine groups or latent reactive groups.

The polymeric reagent compositions include latent reactive groups and cyclic amine groups. The latent reactive groups can be photoreactive or thermally-reactive. The cyclic amine groups are monocyclic groups a having 4- to 7-membered heterocyclic ring, wherein the ring members include at least three carbon atoms, one to three nitrogen heteroatoms, zero to one oxygen heteroatoms. A cyclic halamine group is a cyclic amine group that additionally includes at least one halogen, preferably chlorine or bromine. The halogen can be bound to a nitrogen heteroatom. Alternatively, halogen can be bound to a nitrogen atom that is not a member of the cyclic amine ring. For example, one preferred cyclic amine group is melamine. In this preferred embodiment, the halogen is bound to a nitrogen atom that is pendent from the triazine ring (as opposed to being bound to a nitrogen heteroatom within the triazine ring).

The latent reactive groups and cyclic amine groups are pendent from the polymeric backbone. “Pendent” generally refers to the attachment of one or more chemical groups, such as latent reactive groups, to the polymeric backbone, but not necessarily within the polymeric backbone. “Pendent” can be used to define the location of chemical group attachment on the polymer. For example, chemical groups can be pendent on the backbone anywhere along its length, or pendent at either terminus of the backbone, or both.

One or more latent reactive groups can be pendent along the polymeric backbone at any position and can be spaced in a random or ordered manner. In addition, more than one latent reactive group can be pendent from a particular monomeric unit of the reactive polymer.

Similarly, cyclic amine groups can be pendent along the polymeric backbone at any position and can be spaced in a random or ordered manner. In addition, depending upon the type of cyclic amine groups to be provided as part of the polymeric reagent, and on the application of the reagent composition, more than one type of cyclic amine group can be pendent from the polymeric backbone. A polymeric reagent composition of the invention can include two or more cyclic amine groups, and the number of cyclic amine groups in any given polymeric reagent can vary according to the use intended for the polymeric reagent.

Reagent

In its compositional aspect, the invention provides polymeric reagent compositions having the formula:
Xₐ—Y-Z_{b}
wherein X is a latent reactive group, Y is a polymeric backbone, and Z is a cyclic amine group. In some aspects, a is in the range of about 0.5 to about 90 mole percent, or in the range of about 0.5 to about 30 mole percent; and b is in the range of about 10 to about 99.5 mole percent, or in the range of about 10 to about 50 mole percent. Each of these components will now be described in more detail.
Latent Reactive Group

Polymeric reagents of the invention include a polymeric backbone, a desired average number of latent reactive groups, and a desired average number of cyclic amine groups per average unit length of molecular weight, the combination dependent upon the reagent selected.

As used herein, a “latent reactive group” refers to a chemical group that responds to an applied external energy source in order to undergo active specie generation, resulting in covalent bonding to an adjacent chemical structure (via an abstractable hydrogen). Preferred groups are sufficiently stable to be stored under conditions in which they retain such properties. See for example, U.S. Pat. No. 5,002,582 (Guire et al.). In some embodiments, latent reactive groups can be chosen that are responsive to various portions of the electromagnetic spectrum, with those responsive to ultraviolet and visible portions of the spectrum (referred to herein as “photoreactive”) being preferred. In other preferred embodiments, latent reactive groups can be chosen that are responsive to elevated temperatures (referred to herein as “thermally-reactive”).

Photoreactive Groups

Photoreactive groups respond to a specific applied external ultraviolet or visible light source to undergo active specie generation with resultant covalent bonding to an adjacent chemical structure, for example, as provided by the same or a different molecule. Photoreactive species are those groups of atoms in a molecule that retain their covalent bonds unchanged under conditions of storage but that, upon activation by a specific applied external ultraviolet or visible light source form covalent bonds with other molecules.

Latent reactive (for example, photoreactive) species generate active species such as free radicals and particularly nitrenes, carbenes, and excited states of ketones, upon absorption of electromagnetic energy. Latent reactive species can be chosen to be responsive to various portions of the electromagnetic spectrum, for example, ultraviolet and visible portions of the spectrum.

Photoreactive aryl ketones are preferred, such as acetophenone, benzophenone, anthraquinone, anthrone, and anthrone-like heterocycles (for example, heterocyclic analogs of anthrone such as those having nitrogen, oxygen, or sulfur in the 10-position), or their substituted (for example, ring substituted) derivatives. Examples of preferred aryl ketones include heterocyclic derivatives of anthrone, including acridone, xanthone, and thioxanthone, and their ring substituted derivatives. Particularly preferred are thioxanthone, and its derivatives, having excitation energies greater than about 360 nm. Exemplary photoreactive groups are described in U.S. Pat. No. 5,002,582 (Guire et al.).

Another illustrative class of photoreactive groups that can be associated with the polymeric reagent includes azides. Suitable azides include arylazides (C₆R₅N₃) such as phenyl azide and particularly 4-fluoro-3-nitrophenyl azide, acyl azides (—CO—N₃) such as ethyl azidoformate, phenyl azidoformate, sulfonyl azides (—SO₂—N₃) such as benzensulfonyl azide, and phosphoryl azides (RO)₂PON₃ such as diphenyl phosphoryl azide and diethyl phosphoryl azide.

Diazo compounds constitute another suitable class of photoreactive groups that can be associated with the biocompatible agent and include diazoalkanes (—CHN₂) such as diazomethane and diphenyldiazomethane, diazoketones (—CO—CHN₂) such as diazoacetophenone and 1-trifluoromethyl-1-diazo-2-pentanone, diazoacetates (—O—CO—CHN₂) such as t-butyl diazoacetate and phenyl diazoacetate, and beta-keto-alpha-diazoacetates (—CO—CN₂—CO—O—) such as 3-trifluoromethyl-3-phenyldiazirine, and ketenes (—CH═C═O) such as ketene and diphenylketene.

Exemplary photoreactive groups and the bonds that can be formed following activation of these groups are shown in Table 1.

TABLE 1

| Photoreactive Group | Bond Formed |
|---|---|
| Aryl azides | Amine |
| Acyl azides | Amide |
| Azidoformates | Carbamate |
| Sulfonyl azides | Sulfonamide |
| Phosphoryl azides | Phosphoramide |
| Diazoalkanes | New C—C bond |
| Diazoketones | New C—C bond and ketone |
| Diazoacetates | New C—C bond and ester |
| Beta-keto-alpha-diazoacetates | New C—C bond and beta-ketoester |
| Aliphatic azo | New C—C bond |
| Diazirines | New C—C bond |
| Ketenes | New C—C bond |
| Photoactivated ketones | New C—C bond and alcohol |

The functional groups of such ketones as described herein are preferred since they are readily capable of undergoing the activation/inactivation/reactivation cycle described herein. Benzophenone is a particularly preferred photoreactive group, since it is capable of photochemical excitation with the initial formation of an excited singlet state that undergoes intersystem crossing to the triplet state. The excited triplet state can insert into carbon-hydrogen bonds by abstraction of a hydrogen atom (from a support surface, for example), thus creating a radical pair. Subsequent collapse of the radical pair leads to formation of a new carbon-carbon bond. If a reactive bond (for example, carbon-hydrogen) is not available for bonding, the ultraviolet light-induced excitation of the benzophenone group is reversible and the molecule returns to ground state energy level upon removal of the energy source. Photoactivatable aryl ketones such as benzophenone and acetophenone are of particular importance inasmuch as these groups are subject to multiple reactivation in water and hence provide increased coating efficiency.

Photoreactive groups can be attached to a preformed polymer or monomeric units that are subsequently polymerized to form a polymer, utilizing known chemistry. For example, 4-benzoylbenzoic acid can be reacted with thionyl chloride to provide a photoreactive group capable of attaching to a polymer, such as an amine-containing polymer. Other methods are well known and will not be described further herein.

Thermally-Reactive Groups

In other aspects, the latent reactive group comprises a thermally-reactive group. The terminology “thermally-reactive groups” refers to classes of compounds that decompose thermally to form reactive species that can form covalent bonds. The covalent bonds allow the polymeric reagent containing the thermally-reactive groups to form a coated layer on a surface by, for example, allowing covalent bonding between the polymeric reagent and the surface. Upon application of heat, the polymeric reagent decomposes into a polymer-coupled radical species and a second radical species. In order for the polymeric reagent to become associated with the surface, the thermally-reactive group decomposes to a polymer-coupled radical species that abstracts a hydrogen atom from a target moiety, such as the surface, thereby forming a target radical species. The target radical species then reacts with the polymer-coupled radical species to covalently bond the polymeric reagent to the target moiety. This allows a covalent bond to be formed between the polymeric reagent and the surface.

In some embodiments, a monomeric unit (I), including a thermally-reactive group (of a thermally-reactive polymer), is shown below. X₂—R of the monomeric unit represents the thermally-reactive group. X₁ represents at least a portion of the monomeric unit that is included in the polymeric backbone. Upon application of heat, the thermally-reactive group decomposes to provide products comprising a polymer-coupled radical species (II) and a second radical species (III).

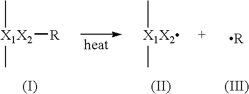

In the least, the thermally-reactive group consists of a pair of atoms having a heat sensitive (labile) bond; exemplary pairs include oxygen-oxygen (peroxide), nitrogen-oxygen, and nitrogen-nitrogen. According to the invention, heat at temperatures not more than 200° C., more typically not more than 110° C., and most typically not more than 80° C., causes the decomposition of the thermally-reactive groups of the polymer thus forming species (II) and (III).

Both carbenes and nitrenes possess reactive electron pairs that can undergo a variety of reactions, for example, including carbon bond insertion, migration, hydrogen abstraction, and dimerization. Examples of carbene generators include diazirines and diazo-compounds. Examples of nitrene generators include aryl azides, particularly perfluorinated aryl azides, acyl azides, and triazolium ylides. In addition, groups that upon heating form reactive triplet states, such as dioxetanes, or radical anions and radical cations, pendent from the polymeric backbone can be used to form the thermally-reactive group. Generally these compounds thermally decompose at temperatures of not more than 200° C. Any of these thermally-reactive groups, as well as mixtures of these thermally-reactive groups, could be attached to thermally stable polymeric backbones or to monomeric units that are polymerized to form polymeric reagents.

In some embodiments, the thermally-reactive group of the polymeric reagent includes a peroxide ‘3(O—O)—group. A monomeric unit of the thermally-reactive polymeric reagent having a peroxide thermally-reactive group is shown by structure (IV): 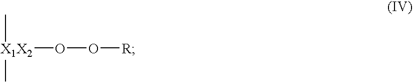
wherein X₁ is a portion of the polymeric backbone, X₂ is a group linking the polymeric backbone to the peroxide that includes an atom that can form a radical (the radical portion of polymeric reagent coupled radical species) following decomposition of the peroxide group; and R is H or any carbon-containing compound that can form an oxy radical (the second radical species) following decomposition of the peroxide group. In some aspects, X₂, R, and the two oxygen atoms are included in a ring structure pendent from the polymeric backbone.

Thermally-reactive polymers having a peroxide group can include other, more specific, thermally-reactive peroxide-containing species. These include, for example, thermally-reactive polymers with a monomeric unit having a thermally-reactive diacyl peroxide group (V): 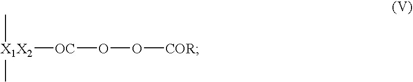
thermally-reactive polymers with a monomeric unit having a thermally-reactive peroxydicarbonate group (VI): 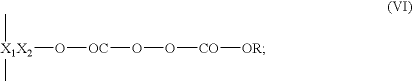
thermally-reactive polymers with a monomeric unit having a thermally-reactive dialkylperoxide group (VII): 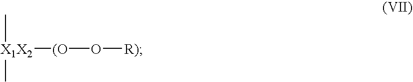
wherein both R and X₂ are carbon-containing group, such as alkyl;
and thermally-reactive polymers with a monomeric unit having a thermally-reactive peroxyester group (VIII): 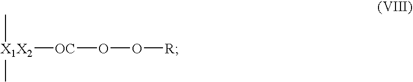
thermally-reactive polymers with a monomeric unit having a thermally-reactive peroxyketal group (IX): 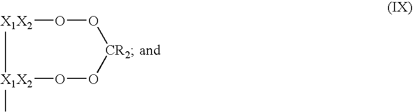
thermally-reactive polymers with a monomeric unit having a thermally-reactive dioxetane group X):

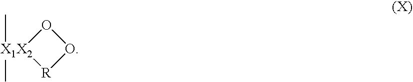

Dioxetanes are four-membered cyclic peroxides that can be dissociated at even lower temperatures than standard peroxides due to the ring strain of the molecules. Activation energies are typically 5-8 kcal/mole lower than simple peroxides with an average bond dissociation energy of 25 kcal/mole. While the initial step in the decomposition of dioxetanes is cleavage of the O—O bond, the second step breaks the C—C bond creating one carbonyl in the excited triplet state, and one in an excited singlet state. The excited triplet state carbonyl can extract a hydrogen from a target moiety, forming two radical species, one of which is on the target moiety and one of which is on the carbon of the carbonyl with the oxygen becoming hydroxy, thereby forming a new covalent bond between the thermally-reactive polymer and the target moiety (the surface).

In a preferred embodiment, the thermally-reactive group comprises a peroxyester group. Suitable monomeric units of this polymer are shown by structure VIII.

In some embodiments of the invention it is preferable to prepare and utilize thermally-reactive groups that have a relatively low activation energy (temperature of decomposition), for example, in the range of 30-60 kcal/mol. A low activation energy can allow for increased rate of reaction of the polymer-coupled reactive group with the surface, thereby generally improving the efficiency and enhancing the rate of the polymeric reagent attachment to the surface. With lower activation energies, side reactions and disproportionation will be less favored. This process is facilitated by providing a thermally-reactive group that can decompose into, for example, a polymer-coupled radical species (II) that is relatively stable.

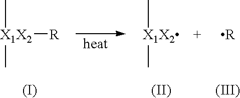

In some embodiments, X₂ of formula I, and in more specific embodiments, X₂ of compound IV (peroxide thermally-reactive group): 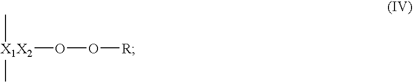
includes a group that provides a stable polymer-coupled radical. Preferred X₂ groups that provide a stable radical include, for example, benzyl and diphenylacetyl groups, which can form polymer-coupled benzyl and diphenylacetyl radicals, respectively, upon decomposition of the polymer. The X₂ group can also include an oxygen-containing moiety thereby improving the reactivity of the polymer-coupled radical species (II); suitable oxygen-containing moieties include, for example, alkyl groups substituted with hydroxyl or methoxy groups. Other preferred X₂ groups include, for example, phenylacetyl, benzoyl, phenylbenzyl, hydrocinnamoyl, mandelyl, phenacyl, phenethyl, thiophenacyl, triphenylmethyl, biphenylacetal, biphenylethyl, and biphenylmethyl. Other X₂ groups include allyl, substituted allyl, and carboxyl.

In a preferred embodiment, the thermally-reactive group is a peroxyester group wherein, upon application of heat, the polymer decomposes into products comprising a polymer-coupled radical species and a second radical species, wherein the polymer-coupled radical species comprises a group selected from benzyl, diphenylacetyl, phenylacetyl, benzoyl, phenylbenzyl, hydrocinnamoyl, mandelyl, phenacyl, phenethyl, thiophenacyl, triphenylmethyl, biphenylacetal, biphenylethyl, biphenylmethyl, allyl, substituted allyl, and alkoxy substituted alkyl.

In some embodiments of the invention it is preferable to prepare and utilize thermally-reactive polymers that provide a highly reactive second radical species upon decomposition of the polymer. These second radicals can promote the formation of surface radical species that then can react with the polymer-coupled radical species to bond the polymer to the surface. In some embodiments the second radical species is an oxy-based radical species such as hydroxy or alkoxy. In one embodiment, the R-group is t-butyl.

Different approaches can be taken for attaching the thermally-reactive group to the polymeric backbone. One approach involves reacting a compound containing a thermally-reactive group, such as a peroxide-containing compound, with a polymer, thereby forming a polymer having a pendent thermally-reactive group. Another approach involves synthesizing a polymerizable monomer coupled to a thermally-reactive group and then polymerizing the monomer, typically with other monomers, using non-thermal polymerization techniques to form a polymer having pendent thermally-reactive groups.

In some cases the thermally-reactive group can be attached to a “preformed” polymer. The preformed polymer or copolymer can be obtained from a commercial source or be synthesized from the polymerization of a desired monomer or combination of different monomers. In one example of preparing the a polymeric backbone having pending thermally-reactive groups, the thermally-reactive groups are reacted with and attached, for example, by covalent bonding, to chemical groups pendent from the backbone of a polymer or copolymer. Such attachments of the thermally-reactive groups can be achieved by, for example, substitution or addition reactions.

In one embodiment, the thermally-reactive polymer is prepared by the nucleophilic coupling of a compound having a thermally-reactive group to a group pendent from the backbone of the polymer. For example, a halogenated compound containing a thermally-reactive group is reacted with a polymer having pendent amine groups. Next, an iodinated compound having a thermally-reactive peroxyester group is reacted with a polymer having a pendent amine group to provide a polymer having pendent thermally-reactive groups (referred to as “iodo-amine coupling”). This method of coupling can proceed to near completion and provide a polymeric backbone with an amount of thermally-reactive groups that is sufficient to allow for the polymer to be coupled to the surface of a substrate after heating the polymer.

A polymer having pendent thermally-reactive groups can be prepared using highly derivatizable preformed polymer as the polymeric backbone. Preferred polymers contain a high number of reactive (derivatizable) groups, such as primary amine groups, relative to the molecular weight of the polymer. Suitable polymers and copolymers include amine-containing monomeric units such as acrylamide and vinylpyrrolidone derivatives.

In other cases polymerizable monomers having thermally-reactive groups are first synthesized and then the monomers are polymerized, thereby providing a polymer having thermally-reactive groups. Preferred monomers include thermally-reactive peroxide-containing groups. In some embodiments, monomers having thermally-reactive groups can be copolymerized with different monomers to create thermally-reactive polymers having one or more desired properties. For example, thermally-reactive copolymers can be prepared having properties such as lubricity and passivity against protein adsorption.

In view of the inventive details and methods of synthesis described herein, or in combination with other methods of synthesis known in the art, thermally-reactive polymers can be prepared having a desired molar percentage of monomers with thermally-reactive groups, and/or a desired molar percentage of co-monomers.

Suitable thermally-reactive groups, and methods of making and using them, are described in U.S. patent application Ser. No. Ser. No. 10/944,384, entitled “Thermally-Reactive Polymers,” filed Sep. 17, 2004.

The polymeric reagent contains latent reactive groups (photoreactive or thermally-reactive) in an amount sufficient to promote the formation of a coated layer that includes the polymeric reagent. The polymeric reagent includes at least one latent reactive group. Generally speaking, the latent reactive group is present in an amount in the range of about 0.5 to about 90 mole percent, or in the range of about 0.5 to about 30 mole percent. When the latent reactive group comprises a photoreactive group, the polymeric reagent preferably includes photoreactive group in an amount in the range of about 0.5 to about 10 mole percent. When the latent reactive group comprises a thermally-reactive group, the thermally reactive group is preferably present in an amount in the range of about 15 to about 50 mole percent.

“Molar percent” can be calculated by dividing the number of chemical groups, such as latent reactive groups, by the number of monomeric units present in the polymeric reagent. For example, a polyacrylamide polymer having 10 molar percent peroxyester groups will have 1 peroxyester group per 10 acrylamide monomeric units of the polymeric reagent.

The inventive polymeric reagent compositions thus provide latent reactive groups that can stably bind the polymeric reagent to a surface. Whether the latent reactive groups comprise photoreactive or thermally-reactive groups, the latent reactive groups preferably bind the polymeric reagent to the surface by abstraction of hydrogen atoms from the surface, thereby covalently binding the polymeric reagent to the surface. These aspects of the invention can provide significant advantages over known methods of preparing biocidal compositions that include halamines. The modified surfaces of the invention include polymeric reagent that is covalently bound, thus providing a source for halamine function that is highly adherent and stable. The modified surfaces can thus be subject to multiple regeneration cycles without concern for loss of the polymeric reagent from the treatment environment. Moreover, the inventive systems and methods can be used to provide biocidal properties to surfaces that are already present within a treatment environment, as opposed to providing an additional component (for example, in the form of a separate filter system) to a treatment environment. The inventive systems and methods thus preferably avoid the use of additional substrates such as solid filter systems that can be required in other treatment options.

Cyclic Amine Group

In accordance with the invention, polymeric reagents are provided that include a polymeric backbone having pendent latent reactive groups and pendent cyclic amine groups. Generally, the cyclic amine group is a 4- to 7-membered heterocyclic ring in which the members of the ring comprise three or more carbon atoms, one to three nitrogen heteroatoms, and zero to one oxygen heteroatoms. Optionally, some of the carbon atoms of the cyclic amine can comprise carbonyl groups. The cyclic amine group is selected to undergo activation with a source of free halogen, whereby a nitrogen atom (whether the nitrogen atom is a member of the ring or an amine pendent from the ring) is halogenated, to thereby provide a cyclic halamine group.

One preferred cyclic amine group is melamine. Melamine (also known as 2,4,6-triamino-1,3,5-triazine, or cyanuramide, C₃H₆N₆) is commercially available. Melamine can be coupled to the polymeric backbone via an amine linkage. In one illustrative embodiment described in the Examples, chlorodiamino triazine can be reacted with a polymeric backbone containing amine groups. The reaction is allowed to proceed with heating at a pH of 9. The reaction product is a polymeric backbone having melamine groups attached via an amine linkage along the polymeric backbone.

When the cyclic amine comprises melamine, one of the amine groups pendent from the triazine ring is utilized to attach the melamine to the polymeric backbone, as described above. The remaining amine groups pendent from the triazine ring can be modified to include halogen. Halogenation is described elsewhere herein. Upon halogenation of the melamine group, one or both of the free amine groups can be halogenated, to thereby provide biocidal function.

Alternatively, monomeric units can be prepared that include melamine groups, and these monomers can be polymerized to form a polymer with pendent cyclic amines.

In light of the present disclosure, one of skill in the art would readily appreciate that other cyclic amines can be utilized in connection with the polymeric reagent compositions of the invention. Some of these cyclic amines will now be described. Generally speaking, these cyclic amines are heterocyclic, monocyclic compounds wherein the ring members are comprised of at least carbon and nitrogen, provided there is at least one nitrogen heteroatom; wherein at least one halogen, preferably chlorine or bromine, is bonded to a nitrogen heteroatom; wherein at least one carbon ring member can comprise a carbonyl group; and wherein one ring member can optionally comprise oxygen.

One class of suitable cyclic amines that can be utilized in accordance with the invention is described in U.S. Pat. No. 5,490,983 (“Polymeric Cyclic N-Halamine Biocidal Compounds,” Feb. 13, 1996). In one aspect, the cyclic amine group can comprise a 4- to 7-membered heterocyclic ring wherein at least 3 members of the ring are carbon, and 1 to 3 members of the ring are nitrogen heteroatoms and 0 to 1 member of the ring is oxygen heteroatom. The cyclic amine is attached to the polymeric backbone via a linkage carbon, wherein the linkage carbon is a member of the heterocyclic ring. The cyclic amine is attached to the polymeric backbone by a linkage that is selected from the group consisting of lower alkyl and phenyl-lower alkyl-phenyl. “Lower alkyl” refers to a hydrocarbon chain, branched or unbranched, having three to eleven carbon atoms. For a “phenyl-lower alkyl-phenyl” linkage, the phenyl group can be substituted or unsubstituted.

Further characteristics of these cyclic amines are as follows: 0 to 2 carbon members comprise a carbonyl group, wherein one non-carbonyl carbon member is attached to the linkage and joined to a substituent selected from the group consisting of C₁-C₄ alkyl, benzyl, and substituted benzyl, wherein 0 to 1 non-carbonyl non-linkage carbon member is joined to a moiety selected from the group consisting of C₁-C₄ alkyl, phenyl, substituted phenyl, benzyl, substituted benzyl, pentamethylene in spirosubstituted form and tetramethylene in spirosubstituted form, wherein each nitrogen heteroatom is joined to a moiety selected from the group consisting of chlorine, bromine, and hydrogen, provided that at least one such moiety is selected from the group consisting of chlorine or bromine.

In another aspect, the cyclic amine group can comprise a 5- to 6-membered ring, wherein 3 to 4 members of the ring are carbon, and 2 members of the ring are nitrogen heteroatom in meta relationship. The cyclic amine is attached to the polymeric backbone via a direct bond or other suitable linkage, the linkage utilizing one of the carbon atoms of the ring. Further characteristics of these cyclic amines are as follows: 0 to 1 carbon member of the ring comprises a carbonyl group; wherein 2 non-carbonyl carbon members of the ring are linked to the methylene linkage and joined to a substituent selected from the group of hydrogen and C₁ to C₄ alkyl; and wherein each nitrogen heteroatom is joined to a moiety selected from the group consisting of chlorine, bromine, and hydrogen, provided that at least one such moiety is selected from the group of chlorine or bromine. Examples of these cyclic amines are illustrated in U.S. Pat. No. 5,490,983.

Other suitable cyclic amines are described in U.S. Pat. No. 6,294,185 (“Monomeric and Polymeric Cyclic Amine and N-Halamine Compounds,” Sep. 25, 2001), U.S. Pat. No. 5,808,089 (“Substituted Heterocyclic Amine Monomers,” Sep. 15, 1998), U.S. Pat. No. 6,020,491 (“Monomeric and Polymeric Cyclic Amine and N-Halamine Compounds”), U.S. Pat. No. 5,670,646 (“Monomeric and Polymeric Cyclic Amine and Halamine Compounds,” Sep. 23, 1997), and U.S. Pat. No. 5,889,130 (“Monomeric and Polymeric Cyclic Amine and N-Halamine Compounds,” Mar. 30, 1999).

In these aspects, the cyclic amine can comprise a 5- to 6- membered heterocyclic ring wherein 3 members of the ring are carbon atoms, 1 to 3 members are nitrogen heteroatoms, and 0 to 1 members are oxygen heteroatoms. One of the carbon atoms of the cyclic amine is substituted with a substituent selected from the group consisting of C₁-C₄ alkyl, benzyl, and alkyl-substituted benzyl. Within the heterocyclic ring, 0 to 2 non-linkage carbon members comprise a carbonyl group, and optionally one non-linkage carbon member can be substituted with a moiety selected from the group consisting of C₁-C₄ alkyl, phenyl, alkyl-substituted phenyl, benzyl, alkyl-substituted benzyl, pentamethylene in spirosubstituted form, and tetramethylene in spirosubstituted form. Upon halogenation, each nitrogen heteroatom is substituted with a moiety selected from the group of chlorine, bromine, and hydrogen, provided that at least one nitrogen heteroatom is substituted with chlorine or bromine.

A carbon atom of these heterocyclic moieties can be joined by a linkage to a polymeric backbone by a bond or para substituted phenyl.

Other suitable cyclic amines are described in U.S. Pat. No. 5,902,818 (“Surface Active N-Halamine Compounds,” May 11, 1999) and U.S. Pat. No. 6,162,452 (“Surface Active N-Halamine Compounds,” Dec. 19, 2000). In these aspects, the cyclic amine comprises a 5-membered ring wherein 3 members of the ring are carbon, 1 member of the ring is a nitrogen heteroatom, and 1 member of the ring is oxygen heteroatom; wherein 1 carbon member comprises a carbonyl group; wherein one noncarbonyl carbon member is attached to an acryloxymethyl linkage to the polymeric backbone. The linkage can be substituted with moieties R₂, R₃, and R₄, which moieties are selected from hydrogen, C₁-C₄ alkyl, benzyl, substituted benzyl, phenyl, and substituted phenyl; wherein the noncarbonyl carbon member is also joined to a moiety R₁ selected from hydroxyl, C₁-C₄ alkyl, benzyl, substituted benzyl, phenyl and substituted phenyl; and wherein the nitrogen heteroatom is joined to a moiety selected from chlorine, bromine, or hydrogen. The cyclic amine is linked at a carbon atom of the ring by an acryloxymethyl linkage to the polymeric backbone.

Further suitable cyclic amines are described in U.S. Pat. No. 6,469,177 (“Surface Active N-Halamine Compounds,” Oct. 22, 2002) and U.S. Publication No. 2003/0064051 A1 (Apr. 3, 2003). In these aspects, the cyclic amine comprises a 5-membered ring wherein 3 members of the ring are carbon, 2 members of the ring are nitrogen heteroatoms; wherein two carbon members each comprises a carbonyl group; wherein 1 nitrogen heteroatom is attached to an acryloxymethyl linkage which is substituted with moieties R₃, R₄, and R₅, which moieties are selected from hydrogen, C₁-C₄ alkyl, benzyl, substituted benzyl, phenyl, and substituted phenyl; wherein the remaining non-carbonyl carbon member is also joined to moieties R₁ and R₂ selected from hydrogen, hydroxyl, C₁-C₄ alkyl, benzyl, substituted benzyl, phenyl, and substituted phenyl; and wherein the remaining nitrogen heteroatom is joined to a moiety selected from chlorine, bromine or hydrogen.

Another suitable cyclic amine comprises a 5-membered ring wherein 3 members of the ring are carbon, and 2 members of the ring are nitrogen heteroatoms; wherein 2 carbon members each comprise a carbonyl group; one nitrogen heteroatom is attached to a hydroxymethyl group and the remaining is attached to a hydrogen, and the remaining non-carbonyl carbon member is joined to moieties R₁ and R₂ selected from hydrogen, hydroxyl, C₁-C₄ alkyl, benzyl, substituted benzyl, phenyl, and substituted phenyl.

Another suitable cyclic amine comprises a 5-membered ring wherein 3 members of the ring are carbon, and 1 member of the ring is nitrogen heteroatom, and the remaining member of the ring is oxygen heteroatom; wherein 1 carbon member comprises a carbonyl group; the nitrogen heteroatom is attached to a hydrogen, and one of the remaining carbon atoms is attached to 2 hydroxymethyl groups. These cyclic amines are linked at a carbon atom of the ring by an acryloxymethyl linkage to the polymeric backbone.

Other discussion of known halamine compositions are found, for example, in U.S. Pat. No. 6,548,054 (“Biocidal Polystyrene Hydantoin Particles,” Apr. 15, 2003), U.S. Pat. No. 5,057,612 (“N,N′-Dihaloimidazolidin-4-ones,” Oct. 15, 1991), U.S. Pat. No. 5,126,057 (“Disinfecting with N,N′-Dihaloimidazolidin-4-ones,” Jun. 30, 1992), U.S. Pat. No. 4,659,484 (“Method for Treating Air-Cooling System's Aqueous Medium,” Apr. 21, 1987), U.S. Pat. No. 4,767,542 (“Method for Disinfecting Aqueous Medium with N,N′-Dihaloimidazolidin-4-ones,” Aug. 30, 1988), and U.S. Pat. No. 4,681,948 (“N,N′-Dihaloimidazolidin-4-ones,” Jul. 21, 1987).

In the above-discussed embodiments, the cyclic amine is attached to the polymeric backbone via a suitable linkage (or spacer). Alternatively, the polymeric reagent can comprise the following structure, in which the cyclic amine forms part of the polymeric backbone: 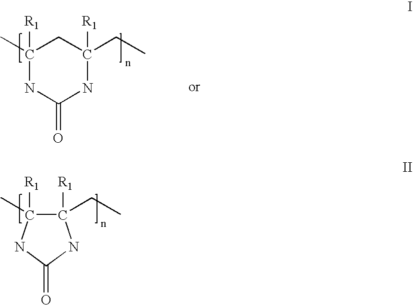
wherein R₁ is selected from the group consisting of hydrogen and C₁to C₄ alkyl; and n is at least 2. Upon halogenation, each of the nitrogen heteroatoms is substituted with a moiety selected from the group of chlorine, bromine, and hydrogen, provided that at least one nitrogen heteroatom is substituted with chlorine or bromine. Such cyclic amine groups are described, for example, in U.S. Pat. No. 6,294,185 (“Monomeric and Polymeric Cyclic Amine and N-Halamine Compounds,” Sep. 25, 2001), U.S. Pat. No. 5,808,089 (“Substituted Heterocyclic Amine Monomers,” Sep. 15, 1998), U.S. Pat. No. 6,020,491 (“Monomeric and Polymeric Cyclic Amine and N-Halamine Compounds”), U.S. Pat. No. 5,670,646 (“Monomeric and Polymeric Cyclic Amine and Halamine Compounds,” Sep. 23, 1997), and U.S. Pat. No. 5,889,130 (“Monomeric and Polymeric Cyclic Amine and N-Halamine Compounds,” Mar. 30, 1999).

The unhalogenated cyclic amine polymers can be prepared from existing inexpensive commercial grade materials.

The polymeric reagent contains cyclic amine groups in an amount sufficient to promote biocidal function to a treatment environment. The present description is not meant to be limiting as to the number of cyclic amine groups in a polymer. A polymer can comprise two or more cyclic amine groups, and the number of cyclic amine groups in any polymer can vary according to the intended use for the polymer. One of skill in the art, upon review of the present disclosure, can readily determine the desired amount of cyclic amine groups and synthesize a polymeric reagent with that amount.

Polymeric Backbone

The polymeric reagents of the invention include latent reactive groups and cyclic amine groups, wherein each of the latent reactive groups and the cyclic amine groups are attached to a polymeric backbone. As discussed, the cyclic amine groups are typically (but not necessarily) pendent from the polymeric backbone. The polymeric backbone generally refers to the polymer chain without addition of groups that provide a particular functionality to the polymer, such as latent reactive groups (photoreactive or thermally-reactive) or cyclic amine groups, which can be specifically coupled to the polymeric backbone. When the polymeric reagent includes thermally-reactive groups, the polymeric backbone includes “thermally-stable linkages,” meaning, specifically, that the covalent bonds between the monomeric units of the polymer are not subject to cleavage upon application of an amount of heat that will cause the decomposition of the thermally-reactive groups pendent from the polymer. In some aspects, thermally-stable linkages are stable to temperatures of typically 200° C. or more.

In some embodiments described herein, however, a portion of the cyclic amine can form part of the polymeric backbone.

The polymeric backbone typically includes carbon and nitrogen containing groups (amine) capable of coupling latent reactive groups (photoreactive and/or thermally-reactive) and cyclic amine groups. Particularly useful groups include amine groups such as primary, secondary, or tertiary amine groups. These pendent amine groups can be used for the coupling of latent reactive groups and cyclic amine groups. Optionally, the polymeric backbone can include one or more atoms selected from nitrogen, oxygen, and sulfur.

Thermally-stable polymeric backbones typically include carbon-carbon linkages and, in some embodiments, can also include one or more of amide, amine, ester, ether, ketone, peptide, or sulfide linkages, or combinations thereof. Examples of suitable polymeric backbones (for use with either photoreactive or thermally-reactive latent reactive groups) include polyesters, polycarbonates, polyamides, polyethers (such as polyoxyethylene), polysulfones, polyurethanes, polyvinyl compounds (such as polystyrene, polyvinylchloride, poly(meth)acrylates, polyvinylpyrrolidone or polyacrylamides), polyimides or copolymers containing any combination of the representative monomer groups. Typical backbones are formed from the polymerization of monomers having ethylenically unsaturated (vinyl) bonds formed from the polymerization of, for example, acrylate monomers, such as methacrylate and ethacrylate monomers; acrylamide monomers, such as methacrylamide monomers; itaconate monomers; and styrene monomers.

In some embodiments, the polymeric backbone is formed by the polymerization of monomeric units of acrylamide and/or acrylamide derivatives, such as hydroxyethylmethacrylate (HEMA). Acrylamide derivatives include, but are not limited to, monomers such as N,N-dimethylacrylamide, aminopropylmethacrylamide and dimethylaminopropylmethacrylamide. In other embodiments, polymeric backbones are formed by the polymerization of monomeric units of vinylpyrrolidone and/or vinylpyrrolidone derivatives. The polymeric backbone can be formed of similar polymerized monomeric units, for example, a homopolymeric backbone such as poly(aminopropylmethacrylamide)) or more typically formed of different polymerized monomeric units (for example, a heteropolymeric backbone such as poly(acrylamide-co—N,N-dimethylamino-propylmethacrylamide)).

Other useful polymeric backbones include polyimine polymers, polylysine, polyornithine, polyethylenimine, polyamidoamine, polypropylenimine, and polyamine polymers or copolymers. Suitable polyamines are commercially available, for example, Lupasol™ PS (polyethylenimine; BASF, New Jersey).

According to the invention, when the polymeric reagent includes thermally-reactive groups, most or all of the linkages of polymeric backbone are thermally stable. Typically, the polymeric reagent including thermally-reactive groups has a backbone that consists essentially of thermally-stable linkages. In alternate embodiments, the polymeric backbone can include one or more thermally-reactive linkages. For example, in some cases thermally-reactive groups can be pendent from either or both termini of the polymer.

When the polymeric reagent composition includes thermally-reactive groups, the polymeric backbone preferably includes water-soluble portions. One illustrative example is N,N-dimethylacrylamide.

The polymeric reagent can be synthesized via one of two routes. In some embodiments, latent reactive groups (photoreactive or thermally-reactive) and cyclic amine groups are conjugated to a premade polymer. Preferably, the premade polymer includes amine groups for attachment of the latent reactive groups and cyclic amine groups. Other groups can be used to attach the pendent latent reactive groups and/or cyclic amine groups, as desired.

In other embodiments, monomers are synthesized to include latent reactive groups, and these derivatized monomers can be polymerized to form a polymeric reagent. For example, vinyl monomers can be derivatized with photoreactive or thermally-reactive groups to provide photoreactive (or thermally-reactive) monomers. Similarly, vinyl monomers can be derivatized with cyclic amine groups to provide monomers that include cyclic amine groups. For example, a vinyl monomer containing an amine group can be derivatized with melamine. Optionally, a spacer or linkage (such as an alkyl spacer, for example C₂ to C₆ alkyl group) can be utilized to attach the cyclic amine to the vinyl monomer.

As previously mentioned, any of the cyclic amines herein described can be provided in the form of monomers that are subsequently polymerized to form a polymer for use in the polymeric reagent compositions. The individual monomers of the polymer can be identical or they can vary. A polymer or copolymer can comprise, for example, one, two, three, four, five, ten, or more different monomers. The monomers can be arranged in random arrangement or block arrangement. The polymers can be prepared in bulk, solution, emulsion, or suspension depending upon the application desired. A “bulk” polymerization can comprise cyclic amine monomer and at least one other monomer wherein the polymerization occurs in the absence of solvent. A “solution” polymerization can comprise cyclic amine monomer and at least one other monomer wherein the polymerization occurs in a solvent, either organic or inorganic. An “emulsion” polymerization can comprise cyclic amine monomer and at least one other monomer wherein the polymerization occurs where water is the solvent along with a surfactant. A “suspension” copolymerization can comprise cyclic amine monomer and at least one other monomer wherein the polymerization occurs where water is the solvent. Each cyclic amine unit and monomeric unit of the polymer can be identical. As discussed herein, “polymer” and “copolymer” are at times used interchangeably. The use of one or the other term is not meant to be limiting except where indicated by the context.

Application of Reagent Composition to Substrate

In some aspects, the invention provides methods for making a modified surface, the method including steps of providing a polymeric reagent composition, the polymeric reagent composition comprising a polymeric backbone, latent reactive groups, and cyclic amine groups, to a surface, and binding the polymeric reagent to the surface. The latent reactive groups can comprise photoreactive groups or thermally-reactive groups. When the latent reactive groups comprise photoreactive groups, the step of binding the polymeric reagent to the surface comprises providing light of a suitable wavelength to the system. When the latent reactive groups comprise thermally-reactive groups, the step of binding the polymeric reagent to the surface is accomplished by heating the system to a suitable temperature.

A preferred cyclic amine group is melamine. In other embodiments, the cyclic amine groups comprise 4- to 7-membered heterocyclic rings in which the members of the ring comprise 3 or more carbon atoms, 1 to 3 nitrogen heteroatoms, and 0 to 1 oxygen heteroatoms.

According to preferred aspects of the invention, the use of latent reactive groups to bind the polymeric reagent to the surface provides stable, consistent coatings on a variety of surfaces. Consistency of coating, while not critical for antimicrobial effect in a treatment habitat, can be beneficial for a number of reasons, as described herein. For example, if uncoated areas are present to a sufficient degree in a treatment environment, these uncoated areas can provide sites for generation of biofilms. Once these biofilms form, they are more difficult to remove, and the bacteria comprising the biofilms are more resistant to antimicrobial agents. Preferably, the use of latent reactive groups provides stable coatings on a variety of surfaces. Such stability, as a result of covalent bonds between the polymeric reagent and the surface, provide coatings that can be utilized for long periods of time. The durability of the coatings, in combination with the ability to regenerate the halamines (through periodic reactivation of the cyclic amine groups), provide improved biocidal treatments that allow for sustained release of halogen that can be reactivated over time.

In some aspects, the cyclic amine group comprises melamine, which is a commonly available and inexpensive compound. In these aspects, then, an efficient and cost-effective manner of making biocidal reagents has been provided.

Methods of Providing Halamine Groups to Surfaces

In some aspects, the invention provide methods of providing halamine groups to a surface, the method including steps of binding a polymeric reagent to a surface, the polymeric reagent composition comprising latent reactive groups and cyclic amine groups, and activating the polymeric reagent composition to provide halamine groups to the polymeric reagent composition.

The latent reactive groups can comprise photoreactive or thermally-reactive groups and are utilized to covalently bind the polymeric reagent composition to the surface. Once the polymeric reagent composition is bound to the surface, the polymeric reagent can be activated by exposing the polymeric reagent composition to a source of free halogen.

The modified surfaces of the invention, which include a polymeric reagent bound to the surface, can be rendered biocidal by exposure to a source of free halogen, such as an aqueous solution of sodium hypochlorite bleach, calcium hypochlorite, chloroisocyanurates, and dichlorohydantoins; or an organic solution of t-butyl hypochlorite, for chlorination. Likewise, the modified surfaces can be exposed to free bromine from such sources as an aqueous solution of molecular bromine liquid, sodium bromide in the presence of an oxidizer such as potassium peroxy monosulfate, and brominated hydantoins.

The polymeric cyclic halamine biocidal compounds of the invention can be prepared by reacting the corresponding unhalogenated polymers, herein referred to as “cyclic amine polymers” with a source of chlorine, bromine, or in the case of the mixed bromochloro derivatives, first a source of bromine and then a source of chlorine, or the reverse. While chlorine gas or liquid bromine can be utilized, other more mild halogenating agents include calcium hypochlorite, sodium hypochlorite, N-chlorosuccinimide, N-bromosuccinimide, sodium dichloroisocyanurate, trichloroisocyanuric acid, tertiary butyl hypochlorite, N-chloroacetamide, N-chloramines, N-bromamines, and the like.

Halogenation of the unhalogenated polymers can be accomplished in aqueous media or in mixtures of water with common inert organic solvents such as methylene chloride, chloroform, and carbon tetrachloride, or in inert organic solvents themselves, at room temperature. The cyclic amine polymer can be a previously utilized cyclic halamine polymer that has become ineffective at killing microorganisms due to inactivation of the halogen moieties. In preferred aspects, the above-described halogenations can be performed in situ. In general, the longer the halogenation reaction occurs, the more likely the polymers are to be fully halogenated. However, “halogenating” or “halogenated” as used herein includes partially as well as fully halogenated. Preferred halogens are chlorine and bromine.

For example, an aqueous solution of 10% CHLOROX™ bleach (sodium hypochlorite, NaOCl) can be used for efficient chlorination which can be accomplished at ambient temperature by spraying or soaking the surface or material with the same. After halogenation, the surface or material is rinsed with water. The modified surface or material will then exhibit biocidal properties for various time periods, dependent upon such factors as the composition of the surface or material, the use pattern (contact with organisms and halogen demand), and the storage temperature. When the bound halogen content drops below an amount that provides efficient biocidal activity, the modified surface or material can be recharged with halogen in the same manner as for the original charging noted herein.

Polymer-Coupled Support/Modified Support

In other aspects, the invention provides modified supports comprising a polymeric reagent composition of a formula
Xₐ—Y-Z_{b}
wherein X is a latent reactive group, Y is a polymeric backbone, and Z is a cyclic amine group. In some aspects of the above formula, a is in the range of about 0.5 to about 90 mole percent, or in the range of about 0.5 to about 30 mole percent; and b is in the range of about 10 to about 99.5 mole percent, or in the range of about 10 to about 50 mole percent.

The inventive coatings and methods can be utilized in combination with any desired substrate material. The inventive coatings can be utilized in combination with any surface that includes abstractable hydrogen atoms. Thus, surfaces can include such abstractable hydrogens or be modified to include abstractable hydrogen atoms.

All microorganisms in aqueous or other solutions or on hard surfaces susceptible to disinfection by free halogen, for example, free chlorine, or combined halogen, such as activated melamine, N-haloimidazolidinones, N-halooxazolidinones, N-halohydantoins, N-haloisocyanurates, and the like, will also be susceptible to disinfection by the polymeric reagents of the invention. Such microorganisms include, for example, bacteria, protozoa, fungi, viruses, and algae.

The polymeric reagent compositions can be employed as disinfectants against undesirable microorganisms in many habitats including surfaces of materials, for example, by treating the material with a biocidally effective amount of the polymeric reagent. Water insoluble biocidal surfaces can include the following applications: for example, oil and water based paints, catheters, medical water supply lines (such as dental water supply lines) surgical tables, surgical instrumentation, medical tables and desktops, medical instrumentation, dental tables and desktops, dental instrumentation, swimming pool liners, fabric materials, medical wrappings, piping, workbenches, counter tops, and the like. Water soluble biocidal surfaces can include the following applications, for example, oil and gas tank liners, preservatives can and bag liners, water based paints, and the like. As used herein, a “surface” can include any surface upon which halogen-sensitive microorganisms can dwell and to which a claimed polymeric reagent composition can be bound.

The polymeric reagent compositions described herein can be employed in a variety of disinfecting applications. For example, they can be of importance in controlling microbiological contamination in cartridge or other type filters installed in the recirculating water systems of remote potable water treatment units, swimming pools, hot tubs, air conditioners, and cooling towers, as well as in recirculating air-handling systems used in military bunkers and vehicles and in civilian structures. For example, the polymeric reagents containing halamines can prevent the growth of undesirable organisms, such as the bacteria genera Staphylococcus, Pseudomonas, Salmonella, Shigella, Legionella, Methylobacterium, Klebsiella, and Bacillus; the fungi genera Candida, Rhodoturula, and molds such as mildew; the protozoa genera Giardia, Entamoeba, and Cryptosporidium; the viruses poliovirus, rotavirus, HIV virus, and herpes virus; and the algae genera Anabaena, Oscillatoria, and Chlorella; and sources of biofouling in closed-cycle cooling water systems. The polymeric reagents of the invention can be of importance as preservatives and preventatives against microbiological contamination in paints, coatings, and on surfaces.

One field in which the inventive polymeric reagents can find particular utility is in the medical field for use in water supply systems, for example in dental applications. The polymeric reagents can find utility for use in connection with ointments, bandages, sterile surfaces, condoms, surgical gloves, and the like, and for binding to liners or containers used in the food processing industry. They can be used in conjunction with textiles for sterile applications, such as coatings on sheets or bandages used for burn victims or on microbiological decontamination suits.

Some representative materials that can be made biocidal according to the invention include vinyl, polyurethanes, polystyrene, polyvinyl chloride (PVC), silicon tubing, acrylic films, metals, textile fabric, rubber, concrete, wood, glass, bandaging, plastic, synthetic fibers, wood, chitin, chitosan, cement grout, latex caulk, porcelain, and marble.

Biocidal Surfaces

In some aspects, the invention provides halamine-modified surfaces. These halamine-modified surfaces include a polymeric reagent composition bound to a surface, the polymeric reagent composition having a formula
Xₐ—Y-Z_{b}
wherein X is a latent reactive group, Y is a polymeric backbone, and Z is a cyclic amine group bearing a halogen. In some aspects, a is in the range of about 0.5 to about 90 mole percent, or in the range of about 0.5 to about 30 mole percent; and b is in the range of about 10 to about 99.5 mole percent, or in the range of about 10 to about 50 mole percent. The halogen is preferably chlorine or bromine. The latent reactive group is a photoreactive group or thermally-reactive group. The latent reactive group is selected to bind the polymeric reagent to the surface. The cyclic amine group is preferably melamine. The cyclic amine group can be activated, once the polymeric reagent is bound to the surface, by exposing the polymeric reagent to a source of free halogen. Upon activation, halogen atoms (such as chlorine or bromine) are attached to one or more of the available amine groups of the cyclic amine, and in the case of melamine, one or both of the amine groups pendent from the triazine ring that are not used to attach the melamine to the polymeric backbone. The activated polymeric reagent thus provides a halamine surface.

The cyclic amine can be a 4- to 7-membered heterocyclic ring in which the members of the ring comprise 3 or more carbon atoms, 1 to 3 nitrogen heteroatoms, and 0 to 1 oxygen heteroatom. In these embodiments, the cyclic amine can be activated, once the polymeric reagent is bound to the surface, by exposing the polymeric reagent to a source of free halogen. Upon activation, halogen atoms (such as chlorine or bromine) are attached to one or more of the nitrogen heteroatoms of the cyclic amine. The activated polymeric reagent thus provides a halamine surface.

The inventive biocidal surfaces can be regenerated for multiple cycles of use. Once a surface becomes ineffective at killing microorganisms due to inactivation of the halogenated moieties, the surface can be regenerated by contacting the surface with a composition including free halogen (for example, by passing or wiping an aqueous solution of free halogen over the coated surface). Additionally, the polymeric reagent can be created or regenerated in situ by adding a stoichiometric amount of free halogen, either chlorine or bromine, to a cyclic amine polymer bound to a surface of a material. Thus, also, the polymeric reagent containing unhalogenated cyclic amine groups can be provided at a surface as described herein, and this polymeric reagent can later, at an advantageous time, be halogenated in situ to render it biocidal.

The cyclic halamine biocidal polymeric reagents described herein can also be employed together with sources of active disinfecting halogen such as free chlorine or bromine, or the various halamine sources of the same.

While not intending to be bound by a particular theory, the mechanism of action of the inventive biocidal surfaces is believed to be a result of surface contact of microorganisms with chlorine or bromine covalently bound to the cyclic amine groups of the bound polymeric reagent. The chlorine or bromine atoms are transferred to the cells of the microorganisms where they cause inactivation through a mechanism not completely understood, but probably involving oxidation of essential groups contained within the enzymes comprising the organisms.

In some aspects, the inventive modified surfaces can provide significant advantages over prior technology. For example, the modified surfaces, once activated by halogenation, are much more effective biocidally against pathogenic microorganisms, such as Staphylococcus aureus and Pseudomonas aeruginosa, encountered often in medical applications, as compared to quaternary ammonium salts. The latent reactive groups through which the polymeric reagent compositions are bound to the surface provide stable covalent attachment of the polymeric reagents to the surface, thereby providing a long-term biocidal surface that can be activated for numerous cycles. Moreover, the flexibility in terms of reactive group choice (photoreactive and thermally reactive) allows significant flexibility in the choice of surface material that can be provided with the inventive biocidal surfaces. For example, the use of thermally-reactive groups to bind the polymeric reagent to the support allows interior surfaces (such as, for example, water lines) that are otherwise inaccessible (for example, to installation of filters or other additional components to the system), to be easily coated according to inventive methods.

The inventive polymeric coating reagents have demonstrated excellent coating consistency when applied to various substrates. Coating consistency is a desirable feature in applications where it is desirable to provide biocidal properties to a surface. However, it will be readily appreciated that it is not required that the coating be consistent or necessarily uniform, since the mode of action of the inventive reagents and compositions is by exposure of a halogen (chlorine, bromine) to microorganisms. Thus, so long as a sufficient amount of halogen is present at the modified surfaces to keep microorganism levels at desired amounts, the modified surfaces will be effective.

The biocidal function of such halamine-modified supports can be assessed as follows. Microbiologically contaminated media (such as water) is placed in contact with the surface coated with polymeric reagent composition. The contact time is measured, which is the amount of time required for the polymeric reagent composition to kill a substantial amount of the microorganism; depending upon the application, the contact times will vary. Illustrative methods for assessing biocidal function are described in the Examples.

Methods for Treating Environment

The invention further relates to methods for treating an environment suspected to contain (or become exposed to) undesirable microorganisms, the method including steps of providing the treatment environment with novel polymeric reagent compositions, the polymeric reagent composition comprising a polymeric backbone, a latent reactive group attached to the polymeric backbone, and cyclic amine groups attached to the polymeric backbone, wherein the cyclic amine groups are activated to provide halamine groups. The treatment environment is typically a habitat for halogen-sensitive microorganisms. Preferably, the polymeric reagent composition is provided in the form of a coating on a surface within the treatment environment.

In these aspects, the polymeric reagent composition has a formula
Xₐ—Y-Z_{b}
wherein X is a latent reactive group, Y is a polymeric backbone, and Z is a cyclic amine group bearing a halogen. In some aspects, a is in the range of about 0.5 to about 90 mole percent, or in the range of about 0.5 to about 30 mole percent; and b is in the range of about 10 to about 99.5 mole percent, or in the range of about 10 to about 50 mole percent. The halogen is preferably chlorine or bromine. The latent reactive group is a photoreactive group or thermally-reactive group. The latent reactive group is selected to bind the polymeric reagent to the surface. The cyclic amine group is preferably melamine. The cyclic amine group can be activated, once the polymeric reagent is bound to the surface, by exposing the polymeric reagent to a source of free halogen. Upon activation, halogen atoms (such as chlorine or bromine) are attached to one or more of the available amine groups of the cyclic amine, and in the case of melamine, one or both of the amine groups pendent from the triazine ring that are not used to attach the melamine to the polymeric backbone. The activated polymeric reagent thus provides a halamine on a surface within the treatment environment.

The cyclic amine can be a 4- to 7-membered heterocyclic ring in which the members of the ring comprise 3 or more carbon atoms, 1 to 3 nitrogen heteroatoms, and 0 to 1 oxygen heteroatom. In these embodiments, the cyclic amine can be activated, once the polymeric reagent is bound to the surface, by exposing the polymeric reagent to a source of free halogen. Upon activation, halogen atoms (such as chlorine or bromine) are attached to one or more of the nitrogen heteroatoms of the cyclic amine. The activated polymeric reagent thus provides a halamine surface.

During treatment, the polymeric reagent containing halamine can be activated by providing a source of free halogen to the polymeric reagent on a periodic basis, to maintain a desired amount of halogen to the treatment environment. Such periodic basis can be on the order of days to weeks. In some embodiments, the polymeric reagent is reactivated in approximate one-week intervals. Activation and reactivation can be performed using methods described herein, as well as any other known method that provides a source of free halogen.

The invention will now be described with reference to the following non-limiting examples.

### EXAMPLES

General Procedures

For the examples, the following general procedures were followed.

Bacterial Culture Preparation

A frozen culture of Pseudomonas aeruginosa (ATCC 700888) was removed from a storage container by sterilized forceps and transferred to a 15 ml sterile centrifuge tube. 400 μl of sterile tryptic soy broth (TSB) (VWR brand, West Chester, Pa.) was added to rehydrate the pellet. An additional 5.6 ml of TSB was added to the tube and the entire mixture was incubated overnight at 37° C. 1 ml of this overnight culture was then aliquoted into 5 ml of TSB and incubated overnight at 37° C. To each 6 ml culture, 1 ml of sterile glycerol (pre-warmed to 37° C.) was added. From this culture, 1.75 ml was aliquoted into 2 ml Erlenmeyer tubes, placed in a Styrofoam container and frozen at −80° C. for later use. When desired, an aliquot was thawed and streaked onto a Mueller-Hinton II plate for isolation. This plate was incubated overnight at 37° C. The next day, 50 mls of sterile TSB was inoculated with an isolated colony using a disposable loop. The inoculated TSB was incubated overnight at 37° C. on an environmental shaker at 150 rpm (New Brunswick Scientific Innova 4080, Edison, N.J.). For biofilm loop reactor, this solution was used as is.

For direct challenges: the next day, the bacteria were pelleted at 8000 rpm at 4° C. for 10 minutes in a refrigerated centrifuge (Beckman Coulter XR-22, Fullerton, CA) The supernatant was gently decanted, and the cells resuspended in approximately 15 mls of sterile 1× phosphate buffered saline (PBS) (Sigma Chemicals, St. Louis, Mo.). The concentration was adjusted to an optical density (OD) of 0.4-0.5 (versus a 1× PBS blank) at 620 nm in a UV-Vis spectrophotometer (Shimadzu, Columbia, Md.), and this optical density gives approximately 10⁸ colony forming units per milliliter (cfu/ml). This standardized suspension was then diluted 1:100 into sterile 1× PBS and used as the challenge inoculum.

The challenge inoculum was either used directly onto coated pieces, or used in the bioreactor.

Direct Challenge Procedure

For the direct challenge, 100 μL of the challenge inoculum was pipetted onto each surface. After 30 minutes of contact with the surface, 25 μL of each of the challenge inocula was removed and diluted 1:100 (pipetted 25 μL into 2.5 mLs sterile 1× PBS)—this was the 1^{st} dilution. Two subsequent 1:10 dilutions were then made (500[L into 4.5mLs sterile 1× PBS)—these were the 2^{nd} and 3^{rd} dilutions, for overall dilutions of 1:1000 and 1:10,000 respectively. Finally, 100 μLs of the 2^{nd} and 3^{rd} dilutions were plated onto Mueller-Hinton II agar plates (Sigma Chemicals, St. Louis, Mo.) in duplicate for cfu enumeration. To minimize any potential effect due to different dwell times during the plating process, one sample for each condition was plated first, then the second sample was plated. All plates were then placed in an incubator at 37° C. overnight and the next day the colonies were counted.

Activation Procedure of Tubing

The tubing to be activated was filled with a freshly prepared solution of 1 ml glacial acetic acid, 20 mls distilled water (DI H₂O), and 38 mls 12-13% NaOCl for at least 1 hour under static conditions at room temperature. Activated tubing was then placed in a 2L beaker filled with DI H₂O overnight to allow residual chlorine to dissipate. The tubing was then rinsed briefly with DI water and without significant drying, attached to the bioreactor valve manifold. In order to reactivate tubing following set-up, a syringe filled with freshly prepared activating solution was used to fill and then rinse the tubing. The activating solution remained in the tubing for one hour and then was rinsed three times with DI H₂O.

Activation Procedure of Coated Pieces

The samples to be activated (generally 1×1 inch square polyvinyl chloride (PVC) coverslips) were placed in clean 50 mL screw-cap centrifuge tubes and 15-20 mLs of activating solution (consisting of the ratio: 1 ml glacial acetic acid, 20 mls DI H₂O, and 38 mls 12-13% NaOCl). The samples were allowed to soak in activating solution for 1 hour, then the samples were placed into clean 50 mL screw cap centrifuge tubes and rinsed 3 times with 25-30 mLs DI water. Finally the pieces were soaked overnight in 25-30 mls of DI water on an orbital shaker at 125 rpm. Sample pieces were stored in DI water at all times, to avoid air oxidation of the coatings.

DPD (N,N-diethyl-1,4-phenylenediamine) Chlorine Elution Method

After activation, the sample coupons were cut in half and placed in clean 20 ml scintillation vials. 5 ml of DI water were placed in each vial, and the vials were placed on an orbital shaker at 125 rpm under ambient conditions. The water was taken out daily, the sample coupons were rinsed twice with 20 mL of DI water, then placed in a fresh 5 ml of DI water for further chlorine elution. Of the 5 ml of each daily elution sample, 100 μl was extracted and combined with 100 μl from a solution of one DPD 1 and one DPD 3 tablet from the DPD (N,N-diethyl-1,4-phenylenediamine) kit for chlorine elution (Orbeco Analytical Services Inc. Farmingdale, N.Y.) in 5 ml of DI water as per manufacturer's procedures. The resulting 200 μl was placed in a 96 well plate and read on a spectrophotometer (Molecular Devices, model, location) at 530 nm and 570 nm. The measurements were compared to a standard curve made from a freshly prepared solution of 50 μl of 12-13% sodium hypochlorite aqueous solution in 100 ml of DI H₂O, 270 μl of this solution was then diluted with 730 μl of DI H₂O to give a solution of 8 ppm. This standard 8 ppm solution was serially diluted seven times to make standards for the standard curve.

### Example 1

### Preparation of Representative Polymeric Reagent including Photoreactive Groups and Melamine

A reagent was prepared that included aminopropyl methacrylamide (APMA) as a polymeric backbone and photoreactive groups attached to the polymeric backbone. A melamine group was then added to the reagent. Preparation of this reagent was as follows.

N—(3-Aminopropyl)methacrylamide hydrochloride (APMA) was prepared as described in Example 2 of U.S. Pat. No. 6,762,019. N[3-(4-benzoylbenzamido)propyl]methacrylamide (BBA-APMA) was prepared as described in Example 3 of U.S. Pat. No. 6,762,019. Copolymerization of APMA and BBA-APMA was performed as follows: a solution of BBA-APMA, AIBN, TEMED and DMSO was bubbled with argon. A solution of APMA/HCl in DI H₂O, was bubbled with argon, and the two solutions were combined. The mixture was bubbled with argon for an additional period, then sealed and stirred in 55° C. overnight. The polymer solution was dialyzed against DI H₂O and then lyophilized. The resulting copolymer had the general structure shown as Compound A:

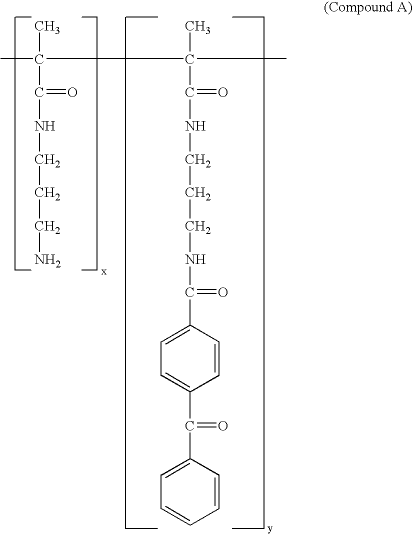

Compound A (1.45 g) was dissolved in 150 ml DI water under heating and stirring. Once the Compound A was dissolved, 0.5 g chlorodiamino triazine (Aldrich Chemicals, Milwaukee, Wis.) was added and the reaction was heated to boil. The pH of the solution was maintained at pH 9 by adding 10% NaOH dropwise. Once the solution became clear, the heat was removed and the reaction flask was cooled down on ice. Then 6 ml acetic anhydride was added to the mixture and the reaction was heated to 90° C. for 30 minutes. The solution was filtered and dialyzed (Dialysis tubing, Fisher Scientific, Pittsburgh, Pa., MWCO 2,000) against distilled water overnight. White powder product was obtained after lyophilization of the dialyzed solution.

The product was a polymeric reagent including photoreactive groups (BBA) and melamine groups.

### Example 2

### Preparation of Representative Polymeric Reagent including Thermally-Reactive Groups and Melamine

Thermally-reactive melamine polymers were made in three steps—synthesis of the polymer backbone, then derivatization of the polymer backbone with melamine, followed by derivatization with thermally reactive perester moieties.

Synthesis of Polymer Backbone, Poly(DMA:APMA) (50:50):

3 g (16.8 mmol) of Aminopropylmethacrylamide-hydrochloride (APMA-HCl) (Aldrich Chemicals, Milwaukee, Wis.), 0.039 g (0.24 mmol) of 2,2′-azo-bis-isobutyrylnitrile (AIBN) (Aldrich Chemicals, Milwaukee, Wis.) and 1.73 ml (16.8 mmol) of N,N-dimethylacrylamide (DMA) (Aldrich Chemicals, Milwaukee, Wis.) were dissolved in 34 ml dimethylsulfoxide (DMSO). Nitrogen gas was bubbled through the reaction solution for at least 5 minutes. Next, 0.052 ml (0.7 mmol) of β-mercaptoethanol (Aldrich Chemicals, Milwaukee, Wis.) and 0.025 ml (0.17 mmol) of N,N,N′,N′-tetramethylethylenediamine (TEMED) (Aldrich Chemicals, Milwaukee, Wis.) were injected to the solution. The reaction flask was sealed under nitrogen and placed in 55° C. oven overnight. After cooled to room temperature, the solution was dialyzed (Dialysis tubing, Fisher Scientific, Pittsburgh, Pa., MWCO 1,000) against DI water at 4° C. overnight and then lyophilized.

Derivatization of Polymer Backbone with Melamine, Poly(DMA:APMA) 50:50 with 20% Melamine:

2.0 g poly(DMA:APMA) (50:50) was dissolved in 100 ml DI water. 0.48 g chlorodiamino triazine (Aldrich Chemicals, Milwaukee, Wis.) was added and the mixture was heated to reflux. A solution of 1N NaOH was added dropwise until the solution became clear. The reaction solution was cooled to room temperature and dialyzed (dialysis tubing, Fisher Scientific, Pittsburgh, Pa., MWCO 2,000) against DI water overnight. White powder product was obtained after lyophilization.

Derivatization with Thermally Reactive Perester Moieties, Poly(DMA:APMA) (50:50)-20% Melamine with 30% Perester:

A halogenated perester compound was first synthesized as follows. Halogenated peroxyester compounds were synthesized and utilized for the synthesis of polymer having thermally activatable peroxyester groups.

Synthesis of 6-bromohexanoyl t-butyl Peroxyester:

All reagents were purchased from Aldrich Chemical, St. Louis, Mo. unless otherwise indicated. 6-bromohexanoyl t-butyl peroxyester was prepared at room temperature (approximately 25-27° C.). 6-bromohexanoyl chloride (3.339 g, 15.6 mmole) was dissolved in 100 ml of anhydrous tetrahydrofuran (THF) under a nitrogen atmosphere. 5 ml of 5.0M t-butylhydroperoxide in decane (25 mmole) was added via syringe, followed by the dropwise addition of 2.4 ml of 1,8-diazabicyclo[5.4.0]undec-7-ene (DBU) (15.6 mmole), which resulted in the formation of a white precipitate (protonated DBU salt) which was filtered off and discarded. The reaction was stirred at room temperature, under a nitrogen atmosphere for three hours, after which it was filtered and concentrated to remove the solvent and excess t-butylhydroperoxide.

¹H NMR was performed using a Bruker 400 MHz NMR to confirm formation of 6-bromohexanoyl t-butyl peroxyester product which showed the following shifts relative to TMS, in CDCl₃: 3.42 ppm (multiplet, 2H), 2.35 ppm (multiplet, 2H), 1.87 ppm (multiplet, 2H), 1.73 ppm (multiplet, 2H), 1.50 ppm (multiplet, 2H), 1.34 ppm (singlet, 9H). The 6-bromohexanoyl t-butyl peroxyester was used in the subsequent step without further purification.

Next, the peroxyester was converted to 6-iodohexanoyl t-butyl peroxyester. The following steps were performed at room temperature. Approximately 4 grams of the 6-bromohexanoyl t-butyl peroxyester preparation was dissolved in 20 ml of acetone. A solution of 4.69 g sodium iodide (31.3 mmole) in 20 ml of acetone was added to the peroxyester solution. Immediate precipitation of sodium bromide occurred as well as formation of a dark red color. The reaction was stirred overnight (subsequent reactions revealed that 30 minutes was sufficient for the reaction to go to completion). The reaction mixture was chilled, then filtered by gravity and the volume was reduced by evaporating off acetone. The mixture containing the reaction product was then re-dissolved in 50 ml of chloroform and washed four times with 50 ml of 1% w/v sodium thiosulfate aqueous solution, then twice with 50 ml of DI H20. The organic layer was dried over sodium sulfate and the solvent was removed by rotary evaporation. The yield of the 6-iodohexanoyl t-butyl peroxyester product was 4.0 g (82% total). ¹H NMR shifts relative to TMS, in CDCl₃ were: 3.20 ppm (multiplet, 2H), 2.35 ppm (multiplet, 2H), 1.87 ppm (multiplet, 2H), 1.73 ppm (multiplet, 2H), 1.50 ppm (multiplet, 2H), 1.34 ppm (singlet, 9H). The 6 -bromohexanoyl t-butyl peroxyester (Compound B) is shown below:

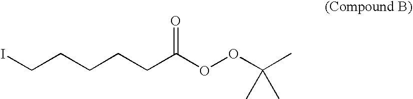

1.7 g of poly(DMA:APMA) (50:50)-20% triazine was dissolved in 115 ml DMSO under bath sonication for 1 hour. 1.125 g of 6-iodohexanoyl t-butyl perester prepared above was added and the mixture was stirred at 45° C. overnight. After cooling to room temperature, the solution was dialyzed (Dialysis tubing, Fisher Scientific, Pittsburgh, Pa. MWCO 1,000) against DI water at 4° C. overnight and then lyophilized.

### Example 3

### Preparation of Representative Monomer including Melamine (Compound C)

This synthesis of a melamine monomer is accomplished in two steps—addition of ethylenediamine to a melamine derivative, and then conjugation of the remaining amino group on ethylenediamine to acryloyl chloride.

Synthesis of Ethylenediamine-Melamine:

2.9 g of 2-chloro-4,6-diamino-1,3,5-triazine was suspended in 30 ml DI water. To this suspension, 5 ml ethylenediamine was added and the mixture was heated to reflux under stirring. 10 ml 10% NaOH solution was added dropwise until the solution became clear. The reaction mixture was cooled to room temperature and filtered. The filtrate was concentrated to 20 ml and placed in the refrigerator overnight. The crystallized product was collected and dried under vacuum.

Synthesis of Melamine-Aminoethyl Acrylamide:

1.53 g (10 mmol) ethylenediamine-melamine was dissolved in 30 ml pyridine. 1.0 g (11 mmol) of acryolyl chloride was added dropwise over 30 min at ˜0° C. The solution was stirred for another 2 hr at room temperature. The mixture was quenched into 100 ml 1N NaOH, the precipitate was collected and washed with DI water three times and then dried under vacuum.

The resulting monomer is shown below as Compound C and can be copolymerized with photoderivatized monomer (such as Compound A in Example 1) or thermally-reactive monomer.

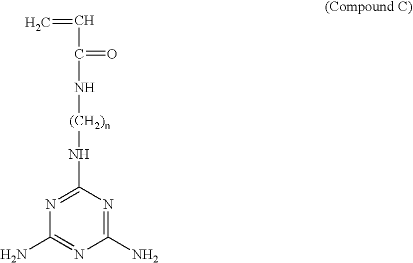

### Example 4

### Preparation of Polystyrene having Antimicrobial Activity

One hundred μl of 10 mg/ml photoreactive melamine polymer (prepared as described in Example 1) in aqueous solution was spread on each of four polystyrene coupons (23 mm ×23 mm). After air-drying for 3 hours, the coupons were illuminated under UV for 3 minutes with the illumination source placed at a distance of 12 inches (Dymax lamp with 400 W PC-2 Ultra-Violet Light-Welder™, Torrington, Conn.).

Two of the four coated and two uncoated coupons were incubated in sodium hypochlorite solution under shaking for 1 hour. The coupons were finally rinsed with DI H₂O three times and air-dried for 24 hr.

Three surfaces were challenged: uncoated chlorinated (UC), a halamine coated surface (CC), and a melamine coated surface that was not chlorinated (NC). Surfaces were tested in duplicates. 150 μl of the challenge inoculum was pipetted onto each surface. At time points of 10, 30 and 60 minutes, 25 μl of each of the 150 μl challenge inocula was removed and diluted 1:100 (25 μl into 2.5 ml sterile 1× PBS). A subsequent 1:10 dilution was then made (0.5 ml into 4.5 ml 1× PBS). Finally, 100 μl of each of the prepared dilutions was placed onto a Mueller Hinton Agar plate (MHII Becton Dickinson) for CFU enumeration. After incubation at 37° C. incubator for 20 hr, the bacteria were counted. Results are shown in Table 2.

TABLE 2
Average cfu/ml retrieved after contact with three surfaces

| | 10 min | 30 min | 60 min |
|---|---|---|---|
| UC | 2.1 | 0.7 | 0.8 |
| CC | 0 | 0 | 0 |
| NC | 1.8 | 1.8 | 0.6 |

All numbers are in millions of cfu/ml.

Results shown in Table 2 indicated that the halamine coated surfaces (CC) resulted in no microbial growth. The melamine coated surfaces that were not chlorinated (NC) showed an initial lower microbial growth (10 minutes) and subsequent microbial level (at 60 minutes) relative to the uncoated chlorinated surfaces (UC), but the microbial load was higher than the activated halamine surfaces. The uncoated chlorinated surfaces (UC) showed the highest initial microbial level (2.1 cfu/ml at 10 minutes), which level subsequently dropped but remained higher than the halamine coated surfaces (CC) at all time points and higher at 60 minutes than the melamine coated surfaces that were not chlorinated (NC). Because the melamine coated surfaces (NC) were not activated by exposure to a source of chlorine, these surfaces showed microbial growth. The halamine coated surfaces provided superior antimicrobial activity.

In addition, the samples were tested for the presence of chlorine by staining with sodium iodide. If chlorine is present sodium chloride and iodide (yellow color) are formed. Several drops of aqueous 5 mg/ml sodium iodide solution were placed on the three samples (uncoated chlorinated (UC), a halamine coated surface (CC), and a melamine coated surface that was not chlorinated (NC)) at room temperature. Yellow color developed within two minutes. Results are shown in Table 3 below.

TABLE 3
Staining with sodium iodide.

| Sample | Color development |
|---|---|
| UC | −−−−− |
| CC | ++++ |
| NC | −−−−− |

Results shown in Table 3 indicated that after rinsing, only the surface containing activated melamine derivatized polymer coating retained chlorine.

### Example 5

### Preparation of PVC having a Representative Polymeric Reagent, Activation and Reactivation

For this Example, PVC coverslips (661×1 inch) were cleaned with isopropanol, then air dried. 34 uncoated sample pieces were used as is.

Twenty (20) photohalamine pieces were prepared as follows: 100 μl of 10 mg/ml photoreactive melamine polymer (prepared as described in Example 1) in DI H₂O solution was pipetted onto the cleaned coverslip and allowed to dry down.

Eight (8) photopolymer pieces were prepared as follows: 100 μl of 10 mg/ml photoreactive polymer without melamine (Compound A) in DI H₂O was pipetted onto the cleaned coverslip and allowed to dry down.

All coated pieces were illuminated for one minute with an ultraviolet lamp having a 400 W Dymax PC-2 Ultra-Violet Light-Welder™ (Dymax, Torrington, Conn.), at a distance of 12 inches.

The pieces were divided and 20 uncoated samples, 20 photohalamine samples, and 8 photopolymer samples were activated by the Activation Procedure of Coated Pieces. Of the original 34 uncoated sample pieces, 14 uncoated samples remained unactivated. Each sample piece was then placed in 5 ml of DI H₂O in a scintillation vial, and assayed daily for chlorine elution and antimicrobial activity. After 7 days, the photoreactive melamine and uncoated pieces were re-activated by following the standard Activation Procedure of Coated Pieces and the chlorine elution and antimicrobial activity were re-tested. The unactivated uncoated samples were added to the antimicrobial activity assays as a control. Activation occurs on day 0. Results are summarized below.

TABLE 4
Chlorine elution in ppm total chlorine.

| Sample | Day 1 | Day 2 | Day 3 | Day 5 | Day 6 | Day 8 |
|---|---|---|---|---|---|---|
| Photomelamine | 1.86 ± 0.62 | 0.33 ± 0.25 | 0.09 ± 0.05 | 0.03 ± 0.04 | ND | ND |
| Photopolymer | 1.99 ± 0.92 | 0.26 ± 0.07 | 0.04 ± 0.06 | ND | ND | ND |
| Uncoated | 0.26 ± 0.35 | ND | ND | ND | ND | ND |
| activated | | | | | | |

*ND: not detectable

TABLE 5
Antimicrobial activity in cfu/ml × 10⁶.

| | | | | Reactivated | | | |
|---|---|---|---|---|---|---|---|
| | | Day | | Day 9 | | Day | |
| Sample | 1 | 2 | 6 | Day 1 | 2 | 6 | 8 |
| Photomelamine | 0, 0 | 0, 0 | 0, 0 | 0, 0 | | | |
| Photopolymer | 0, 0 | NA | 76, 18 | 156, 160 | | | |
| Uncoated | 186, 204 | 154, 168 | 294, 280 | 252, 220 | | | |
| activated | | | | | | | |
| Uncoated | 324, 344 | 230, 182 | 232, 270 | 210, 208 | | | |
| not activated | | | | | | | |
| Reactivated | | | | 0, 0 | 0, 0 | 0, 0 | 0, 0 |
| photomelamine | | | | | | | |
| Reactivated | | | | 288, 284 | 272, 264 | 272, 248 | 292, 288 |
| uncoated | | | | | | | |

TABLE 6
Activation vs. reactivation in chlorine elution levels in ppm.

| | Photomelamine | | Uncoated | |
|---|---|---|---|---|
| Day | Activation | Reactivation | Activation | Reactivation |
| 1 | 2.25 ± 0.59 | 3.45 ± 0.71 | 0.51 ± 0.87 | 0.08 ± 0.37 |
| 2 | 0.40 ± 0.17 | 0.41 ± 0.18 | Not detectable | Not detectable |
| 3 | 0.27 ± 0.10 | 0.25 ± 0.11 | Not detectable | Not detectable |
| 5 | 0.05 ± 0.05 | 0.31 ± 0.09 | Not detectable | Not detectable |
| 7 | 0.05 ± 0.01 | 0.38 ± 0.24 | Not detectable | Not detectable |

Results in Table 4 illustrate the improved chlorine elution provided by representative compositions. Results indicated that sustainable chlorine elution through Day 5 was attainable with the photomelamine composition only. While the samples coated with photopolymer (not including melamine) had a higher chlorine elution level at Day 1, the chlorine was unbound to the surface, and chlorine elution levels for this sample dropped significantly by Day 2 and were undetectable by Day 5. The uncoated activated sample exhibited a small elution level at Day 1, but chlorine elution was undetectable after Day 1.

Results in Table 5 illustrate the improved antimicrobial activity of compositions representative of the invention. As shown, photomelamine compositions maintained superior antimicrobial activity through Day 9, and subsequent to reactivation at Day 9. The photopolymer sample (photoreactive polymer that lacks melamine) demonstrated initial antimicrobial activity at Day 1, but subsequently higher antimicrobial activity relating to the photomelamine subsequent to Day 1. Moreover, the uncoated samples demonstrated higher microbial levels throughout the experiment, whether the samples were activated or not exposed to activating solution.

Results in Table 6 illustrate the improved chlorine elution of surfaces provided with representative antimicrobial compositions relative to uncoated samples. Chlorine elution was maintained through Day 7 for photomelamine samples, while the chlorine elution for uncoated samples was not detectable beginning at Day 2.

### Example 6

### Preparation of Biocidal Surface with Polymeric Reagent including Thermally Reactive Groups

Solutions of the thermally reactive melamine polymer prepared as described in Example 2 were dissolved in DI H20 at 10 mg/ml, then serially diluted six times to provide a range of concentrations 10, 5, 2.5, 1.25, 0.625, 0.312, and 0.158 mg/ml in DI H20. PVC coverslips (1×1 in², VWR brand, West Chester, Pa.) were cleaned by soaking in 70% isopropanol in water for 10 minutes, followed by air drying, then applying 200 μl of polymer coating solution by pipette and air drying. The coated pieces were then heated in an oven at 80° C. overnight, cooled, then placed in 50 ml conical vials with 25 ml of DI H₂O and placed on an orbital shaker at 150 rpm for 10 minutes to rinse. The rinsed pieces were air dried and then activated by the Activation Procedure of Coated Pieces. Activated pieces were subsequently placed in scintillation vials and the relative chlorine concentration was assayed daily and the antimicrobial activity was assayed on an intermittent basis by the Direct Challenge Procedure. The water was changed in each sample daily, by draining the current solution, and replacing with 5 ml of DI H₂O.

Activation occurred on day 0, n=2 samples, with 2 plates per sample.

TABLE 7
Direct Challenge results.

| Coating | Day 2 cfu/plate | Day 7 cfu/plate |
|---|---|---|
| Uncoated | {96, 191} {195, 161} | {˜200, ˜200} {˜200, ˜200} |
| 10 mg/ml | {0, 0} {0, 0} | {0, 0} {0, 0} |
| 5 mg/ml | {0, 0} {0, 0} | {0, 0} {0, 0} |
| 2.5 mg/ml | {0, 0} {0, 0} | {˜200, ˜200} {˜200, ˜200} |
| 1.25 mg/ml | {0, 0} {0, 0} | {˜200, ˜200} {˜200, ˜200} |
| 0.625 mg/ml | {0, 0} {0, 0} | {˜200, ˜200} {˜200, ˜200} |
| 0.312 mg/ml | {0, 0} {0, 0} | {˜200, ˜200} {˜200, ˜200} |
| 0.156 mg/ml | {154, 170} {151, 161} | {˜200, ˜200} {˜200, ˜200} |

TABLE 8
Chlorine Elution results in ppm of total Chlorine.

| Coating | Day 1 | Day 2 | Day 3 | Day 6 | Day 7 |
|---|---|---|---|---|---|
| Uncoated | 0 | 0 | 0 | 0 | 0 |
| 10 mg/ml | 4.65 | 1.05 | 0.82 | 0.41 | 0.17 |
| 5 mg/ml | 1.74 | 0.27 | 0.28 | 0.14 | 0.09 |
| 2.5 mg/ml | 1.29 | 0.18 | 0.15 | 0.02 | 0 |
| 1.25 mg/ml | 0.67 | 0.06 | 0.04 | 0 | 0 |
| 0.625 mg/ml | 0.26 | 0 | 0 | 0 | 0 |
| 0.312 mg/ml | 0.07 | 0 | 0 | 0 | 0 |
| 0.156 mg/ml | 0 | 0 | 0 | 0 | 0 |

Results in Table 7 illustrate the improved antimicrobial properties of representative polymeric reagent compositions. At Day 2, even diluted samples provided with representative polymeric reagent coatings demonstrated superior antimicrobial properties relative to the uncoated samples. At Day 7, samples diluted to 5 mg/ml provided superior antimicrobial properties relative to uncoated samples.

Results in Table 8 illustrate the sustainable chlorine elution for coatings of the various concentrations of photoreactive polymeric reagent.

### Example 7

### Preparation of Thermally Reactive Coverslip vs. Tubing

Solutions of the thermally reactive melamine polymer prepared as described in Example 2 were dissolved in DI H20 at 10 mg/ml, then serially diluted six times to provide a range of concentrations 10, 5, 2.5, 1.25, 0.625, 0.312, and 0.158 mg/ml in DI H20. Fourteen PVC coverslips having dimensions 1×1 in² (VWR brand, West Chester, Pa.) were cleaned by soaking in 70% isopropanol in water for 10 minutes, followed by air drying, then applying 100 μl of polymer coating solution by pipette and air drying. Two sample pieces were coated with each polymer solution. The coated pieces were then heated in an oven at 80° C. overnight, cooled, and ready for assay.

The inner diameter of tubing was coated by cutting a 6 inch length of PVC tubing (VWR brand, West Chester, Pa. ¼ inch inner diameter), filling it with 1 mg/ml thermally reactive melamine polymer prepared as described in Example 2 dissolved in DI H20, with both ends of tubing capped. The tubing was heated in an oven at 80° C. overnight, then drained and air dried. This same procedure was then repeated for a second base coat. This basecoated PVC tubing was attached to a three-way valve, with a 20 ml syringe on one end and additional tubing on the third end to a solution of 10 mg/ml polymer solution in a beaker. The polymer solution was pulled into the syringe, then the valve was rotated and the polymer solution was pushed into the tubing. After a few minutes the polymer solution was then slowly drained via the three way valve into the beaker. This coating procedure was repeated multiple times with one hour incubations in the oven at 80° C. between each coat.

After coating was completed the coverslip pieces and the tubing pieces were assayed in the following manner. The tubing was cut into ⅓ inch segments for testing, this gives a coated surface area of approximately that of the coverslips. Sample coverslips or tubing were immersed in a solution of 1% w/v sodium fluorescein salt in DI H₂O for 15 seconds. The sample was then dipped four times into fresh water rinse solutions to remove excess fluorescein. Samples were air dried, then placed individually in test tubes with 1 ml of 0.1% v/v cetyltrimethylanmronium chloride in water. These sample solutions were placed on an orbital shaker for four hours at room temperature. 100 μl of each sample solution was placed in a microwell plate and the absorbance at 502 nm measured. Results are shown below.

TABLE 9
Coating of Substrates versus Tubing.

| Coverslip Coating | Absorbance | Absorbance | Tubing Coating |
|---|---|---|---|
| 0.157 mg/ml | 0.126 | 0.259 | 1 overcoat |
| 0.312 mg/ml | 0.228 | 0.545 | 2 overcoats |
| 0.625 mg/ml | 0.328 | 0.718 | 3 overcoats |
| 1.25 mg/ml | 0.528 | 0.774 | 4 overcoats |
| 2.5 mg/ml | 0.746 | 0.781 | 5 overcoats |
| 5 mg/ml | 1.238 | 0.800 | 6 overcoats |
| 10 mg/ml | 1.045 | | |

Based on these results the amount of coating within the tube reached a maximum at approximately 4 overcoats, and this corresponds to approximately one quarter of that found on coverslips in previous examples.

### Example 8

### Co-Immobilization of Compound A and Thermally Reactive Polymeric Reagent on the Inner Diameter of Tubing

One-foot lengths of PVC tubing (¼ inch inner diameter, VWR brand, West Chester, Pa.) were coated with thermally reactive melamine polymer by filling the tube with 1 mg/ml polymer (prepared as described in example 2) in DI H₂O, capping the ends and incubating at 80° C. for 4 hours. The tubing was then drained and refilled with fresh 1 mg/ml polymer solution and re-incubated overnight at 80° C. The next day, the tubing was drained, cooled, and air dried. This base-coated tubing was further coated by the syringe method described in example 7. 0 n four tubing lengths pure thermally reactive melamine polymer was coated at 10 mg/ml in DI H₂O, for one to four coats with one hour incubations at 80° C. between each coat. On a second set of four tubing lengths, a mixture of 10 mg/ml thermally reactive melamine polymer and 1 mg/ml Compound A in DI H₂O was coated for one to four coats with one hour incubations at 80° C. between each coat. On a third four tubing lengths, a mixture of 10 mg/ml thermally reactive melamine polymer and 5 mg/ml Compound A in DI H₂O was coated for one to four coats with one hour incubations at 80° C. between each coat.

Six ⅓ inch sample pieces were cut from the ends of each tubing piece. Two sample pieces from each coated tube were used for Fluorescein stain determination, as described in Example 7. These results are shown below. The other four sample pieces were used for chlorine elution and antimicrobial activity studies. The pieces were first activated by soaking in bleach for one hour, then rinsing with DI H₂O for 30 minutes. Each piece was then placed in a scintillation vial with 1 ml of DI H₂O, after soaking each night 100 μl of the solution was sampled by the DPD Chlorine Elution Method, the remaining 900 μl of solution was discarded, the piece briefly rinsed with DI H₂O and 1 ml of fresh DI H₂O was added to each vial. This was done for each day of the study.

At the end of seven days, samples for chlorine elution were taken out and assayed for antimicrobial activity. This was done by allowing the tubing to air dry, then placing 100 μl of challenge inoculum on the piece and allowing it to contact the piece for 30 minutes. After 30 minutes 25 ml of the droplet was taken up by pipette and diluted into 2.5 ml 1× PBS, then 0.5 ml of this solution was diluted with 4.5 ml 1× PBS. From this final dilution 100 μl was plated onto Mueller-Hinton II agar plates. The plates were incubated overnight at 37° C. and then counted.

TABLE 10
Results of Fluorescein staining in absorbance units at 502 nm.

| Number of | 10 mg/ml | | 10 mg/ml Thermal |
|---|---|---|---|
| coating | Thermal | 10 mg/ml Thermal | 1 mg/ml |
| layers | Only | 5 mg/ml Compound A* | Compound A* |
| 1 | 0.135 | 0.233 | 0.108 |
| 2 | 0.451 | 0.508 | 0.170 |
| 3 | 0.260 | 0.716 | 0.224 |
| 4 | 0.581 | 1.147 | 0.761 |

*Pieces co-coated with Compound A required a 1:10 dilution in order to be within the measurement range.

Fluorescein staining demonstrated that the addition of Compound A increased the amount of polymer immobilized on the surface over tenfold.

TABLE 11
Results of Chlorine elution in ppm of total chlorine.

| | 10 mg/ml | | | | 10 mg/ml | | 5 mg/ml | | 10 mg/ml | | 1 mg/ml | |
|---|---|---|---|---|---|---|---|---|---|---|---|---|
| Day | Thermal | | | | Thermal | | Cmpd 2 | | Thermal | | Cmpd 2 | |
| Coats | 1 | 2 | 3 | 4 | 1 | 2 | 3 | 4 | 1 | 2 | 3 | 4 |
| 1 | 68.1 | 43.1 | 53.6 | 36.1 | 67.6 | 34.5 | 26.7 | 66.4 | 55.1 | 55.7 | 50.4 | 45.1 |
| 2 | 5.1 | 2.9 | 1.6 | 1.5 | 3.8 | 1.3 | 3.8 | 6.4 | 4.8 | 4.5 | 6.4 | 3.9 |
| 6 | 0.1 | 0.2 | 0.2 | 0.3 | 0.2 | 0.2 | 0.6 | 0.7 | 0.4 | 1.1 | 1.5 | 0.9 |
| 7 | 0.0 | 0.1 | 0.1 | 0.1 | 0.1 | 0.1 | 0.3 | 0.4 | 0.2 | 0.6 | 0.9 | 0.5 |

Addition of Compound A also increased the amount of chlorine eluted into water over a period of days.

TABLE 12
Results of Antimicrobial activity in 10⁶ cfu/ml on Day 7.

| Coating | 1 coat | 2 coats | 3 coats | 4 coats |
|---|---|---|---|---|
| 10 mg/ml | 76, 85, | 37, 46, | 0, 0, | 12, 15, 43, 47 |
| Thermal Mel. | TNTC, TNTC | 43, 52 | 42, 45 | |
| 10 mg/ml | 0, 0, 0, 0 | 0, 0, 0, 0 | 0, 0, 0, 0 | 0, 0, 0, 0 |
| Thermal | | | | |
| 5 mg/ml | | | | |
| Compound A | | | | |
| 10 mg/ml | 45, 52, 0, 0 | 0, 0, 0, 0 | 0, 0, 0, 0 | 0, 0, 0, 0 |
| Thermal | | | | |
| 1 mg/ml | | | | |
| Compound A | | | | |

**In the table, TNTC represents too numerous to count.

Finally, results indicated that utilization of Compound A provided a definite improvement in antimicrobial activity of the coatings.

### Example 9

### Bioreactor Assay on Coated Tubing

Two 4 inch segments of PVC tubing (¼ inch inner diameter, VWR brand, West Chester, Pa.) were filled with a 1 mg/ml aqueous solution of thermally reactive melamine polymer, capped at both ends, and baked for at least 4 hours at 80° C. The coating solution was then drained. The tubes were then filled with fresh 1 mg/ml thermally reactive melamine polymer solution and baked overnight at 80° C. Following this, the tubes were coated with a solution of 10 mg/ml thermopolymer, 5 mg/ml Compound A aqueous solution using the syringe method described in Example 7. This was done four times with at least 1 hour of baking at 80° C. between coatings.

Coated PVC tubing was filled with a freshly prepared solution of 1 ml acetic acid, 20 mls DI H₂O, and 38 mls 12-13% NaOCl for at least Ihour. Activated tubing was then placed in a 2L beaker filled with DI H₂O overnight to allow residual chlorine to dissipate. In order to reactivate tubing following set-up, a syringe filled with freshly prepared activating solution was used to fill and then rinse the tubing, as described in the general procedures. The reactivation occurred on Day 7.

The bioreactor was set-up over a period of two days in a biosafety cabinet. The bioreactor is a modification of a commercial rotating disk reactor (Biosurface Technologies, Corp. Bozeman, Mont.). This commercial bioreactor is designed such that given a specific flow rate the bacteria within the reactor will maintain at a given cfu/ml. The bioreactor is composed of a 1 L beaker equipped with stirrer, inlet, outlet, and flowbreak. A peristaltic pump is used to pump media through tubing to the bioreactor inlet, then out the bottom to a waste container. In the experiments described herein, a manifold was attached to the waste stream, such that the waste stream was divided into four pieces of tubing, then recombined. The four pieces of tubing can be attached and detached through a three-way valve at each end. By attaching the tubing to be assayed to the putative waste stream, each tubing piece “sees” an equivalent environment of reproducible amounts of bacteria. On the first day the beaker was filled with ˜300 mLs of sterile 1× PBS and inoculated with ˜30 μL of an overnight P. aeruginosa culture(approximately 10⁸-10⁹ cfu/ml) as described in the general procedure section. On the following day the apparatus was assembled in its entirety. Four 4 inch sample tubing pieces were attached to the manifold—two uncoated pieces and two coated pieces (pre-activated), the two pieces were each duplicates. The bioreactor was sampled two to three times daily. The samples were taken after closing the shut-off valves for 30 minutes. Samples were drained through 3-way luer lock valve between the two shut-off valves to prevent mixing. The bioreactor flow time was regulated with a GraLab 645 timer. This timer was set for 5 minutes of flow followed by 25 minutes of stagnation. Samples were taken by closing off the valves to isolate the solution in the tubes directly after the 5 minutes of flow then allowing them to sit for 30 minutes. Samples were also taken from the beaker through an arm at the top of the container to determine the cfus/ml of the standard suspension. Samples were diluted 1:100, and 1:10,000 into sterile 1× PBS. One hundred μLs of each of these dilutions, along with the original undiluted sample were plated in duplicate on Mueller-Hinton II agar and then incubated overnight at 37° C. Plates were then removed and colonies were counted.

TABLE 13
Results of Plating in 10⁴ cfu/ml, inoculation occurs on day zero.

| Day | Bioreactor | Uncoated 1 | Uncoated 2 | Coated 1 | Coated 2 |
|---|---|---|---|---|---|
| 1 | 296 | 197 | 218 | 0 | 0 |
| 2 | 129 | 189 | 193 | 0 | 0 |
| 5 | 249 | 304 | 249 | 5 | 241 |
| 6 | 150 | 235 | 305 | 162 | 129 |
| 7* | 311 | 300 | 234 | 0 | 0 |
| 8 | 300 | 132 | 46 | 0 | 0 |
| 9 | 198 | 300 | 300 | 0 | 0 |
| 13 | 41 | 279 | 251 | 0 | 49 |
| 14 | 280 | 300 | 240 | 0 | 250 |

*reactivation occurred on Day 7, as well as a reinoculation with 30 μl of fresh overnight culture.

Results illustrate the improved antimicrobial properties of polymeric reagent coatings representative of the invention. Coated samples provided superior antimicrobial function, and this antimicrobial function was capable of regeneration at Day 7. The coated samples provided significant reduction in microbial growth. At reactivation, microbial growth was reduced to zero, while microbial load remained high (and showed only a slight reduction upon reactivation at Day 7, which could be attributed to introduction of the free chlorine) for uncoated samples.

### Example 10

### Consistency of Polymeric Reagent Coating on Tubing Inner Diameter

Two 2 ft sections of food grade PVC tubing (VWR brand, West Chester, Pa., ⅛ inch inner diameter) were coated by the method described in Example 9, with 2 base coats and 4 overcoats of 10 mg/ml thermally reactive melamine polymer and 5 mg/ml Compound A. The two-foot long pieces were cut into four 5 inch segments, labeled 1 to 4, and ½ inch was cut off each 5 inch segment. The ½ inch pieces were assayed by the fluorescein method described in Example 7, and compared to a standard curve of polymer coating on coverslips serially diluted from 10 mg/ml to 0.157 mg/ml to give the mg of total polymer on the tubing. Results are shown below.

TABLE 14
Coating Consistency.

| Sample | mg polymer/cm tubing |
|---|---|
| Section 1 Tube 1 | 0.122 |
| Section 2 Tube 1 | 0.034 |
| Section 3 Tube 1 | 0.034 |
| Section 4 Tube 1 | 0.042 |
| Section 1 Tube 2 | 0.117 |
| Section 2 Tube 2 | 0.043 |
| Section 3 Tube 2 | 0.036 |
| Section 4 Tube 2 | 0.048 |

The results show that there was more coating on the bottom edge (section 1) of each tubing length, but that the rest of the tubing was fairly evenly coated.

### Example 11

### Antimicrobial Activity of the Biocidal Surfaces against Wildtype DUWL Bacteria

Several Dental Unit Waterlines (DUWL) water samples were aseptically collected from a downtown Minneapolis dental office. Briefly, water samples were collected from four separate rinse water handpieces. Liquid Mueller-Hinton broth(MHB) was inoculated with approximately 100 μl of the DUW for each sample. Following incubation, turbid liquid media was then streaked onto Mueller-Hinton II agar. Three of the four DUW samples yielded growth following inoculation into MHB. Turbid media was then plated and primarily three colony types appeared following incubation. Two of these appeared to be Gram-positive bacilli and the other a Gram-negative bacillus. The Gram-negative bacillus did not routinely grow when inoculated into MHB. Both Gram-positive bacilli did grow routinely when inoculated into MHB. One was chosen for further identification. This bacillus was then isolated and subject to several tests.

The first test used to determine the species of the Gram-positive bacillus was the Schaeffer-Fulton spore stain. In this test a smear was prepared of a several day old colony on a glass slide. The smear was then heat fixed and immersed in a solution of malachite green. The slide was then heated until steaming several times in a five-minute period, allowed to cool, rinsed with water, then counterstained with safranin for ˜30 seconds. Vegetative cells then appeared pink and spores green. The Gram-positive bacillus displayed this staining pattern, which allowed the presumptive identification of a Bacillus species. (The only other spore producing Gram-positive bacilli are Clostrida and these are obligate anaerobes.)

The catalase test was also used. This test detects the presence of an enzyme system capable of converting hydrogen peroxide and superoxide into diatomic oxygen and water. The Gram-positive bacillus tested positive for catalase, a trait common to many Bacillus. Colony morphology was also used to determine the species of the Gram-positive bacillus. Bacillus species usually produce gray-white colonies with spreading margins. This was observed for the isolate in question. Motility was determined by preparing a wet-mount and viewing it under a microscope. This test revealed the isolate to be motile and therefore not B. anthracis.

PVC coverslips were spot coated with 200 μl of a 10 mg/ml aqueous solution of thermopolymer. After the coating solution dried down the coverslips were placed in an oven set to 80° C. and allowed to dry overnight. Coated coverslips were immersed in an activating solution consisting of 4 mls Acetic acid, 20 mls DI H₂O, and 38 mls ˜13% NaOCl for at least 1 hour. Coverslips were then thoroughly rinsed and placed in pairs into 50ml polypropylene centrifuge tubes. Tubes containing coverslips were then filled with 5 mls DI H₂O. Activated coverslips were stored 2 per vial in 5 mls DI H₂O. The storage water was changed out each weekday (M-F).

Fresh overnight bacterial cultures were pelleted under ambient conditions, resuspended in sterile 1× PBS, and adjusted to an absorbance between 0.4 to 0.5 at 620nm against a 1× PBS blank. A 1:100 dilution was made of the adjusted suspension and used as the challenge inoculum.

Two coated and two uncoated coverslips were placed in sterile Petri dishes and allowed to dry briefly (<30minutes). Following this, 100 μl of the challenge inoculum was pipetted onto uncoated and coated surfaces. After 30 minutes of contact with the surface, 25μl was removed and diluted 1:100 in sterile 1× PBS. An additional dilution was made by diluting 500 μl 1:10 in 1× PBS. This was plated in duplicate by plating out 100 μl onto Mueller-Hinton II agar. The plates were incubated overnight at 37° C., and the resultant colonies were counted.

TABLE 15
Antimicrobial Activity in 10⁶ cfu/ml.

| Sample | Day 1 | Day 7 | Day 14 |
|---|---|---|---|
| Uncoated PVC | {100, 68} | {156, 166} | {67, 98} |
| coverslip | {76, 95} | {143, 147} | {100, 80} |
| Coated Coverslip | {0, 0} {0, 0} | {0, 0} {0, 0} | {0, 0} {0, 0} |

Results illustrate the improved antimicrobial properties of coverslips provided with coatings representative of the invention. Antimicrobial levels were maintained through Day 14 for the coated samples, while the microbial load of the uncoated PVC coverslips was significantly higher.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims. All patents, patent documents, and publications cited herein are hereby incorporated by reference as if individually incorporated.

We claim:

1. A polymeric reagent of a formula:
Xₐ—Y-Z_{b}
wherein X is a latent reactive group, Y is a polymeric backbone, and Z is a melamine group.

2. The polymeric reagent according to claim 1 wherein the latent reactive group is a photoreactive group.

3. The polymeric reagent according to claim 2 wherein the photoreactive group is a photoreactive aryl ketone.

4. The polymeric reagent according to claim 3 wherein the photoreactive aryl ketone is selected from acetophenone, benzophenone, anthraquinone, anthrone, and anthrone-like heterocycles.

5. The polymeric reagent according to claim 1 wherein the latent reactive group is a thermally-reactive group.

6. The polymeric reagent according to claim 5 wherein the thermally-reactive group comprises a peroxide group.

7. The polymeric reagent according to claim 6 wherein the thermally-reactive group comprises a peroxyester group.

8. The polymeric reagent according to claim 7 wherein the thermally-reactive group comprises a group selected from benzyl, diphenylacetyl, phenylacetyl, benzoyl, phenylbenzyl, hydrocinnamoyl, mandelyl, phenacyl, phenethyl, thiophenacyl, triphenylmethyl, biphenylacetyl, biphenylethyl, or biphenylmethyl.

9. The polymeric reagent according to claim 1 wherein the polymeric backbone is selected from polystyrene, polyvinylchloride, polymethacrylates, polyvinylpyrrolidone and polyacrylamides.

10. The polymeric reagent according to claim 1 wherein the polymeric backbone is selected from polyester, polycarbonate, polyamide, polyether, polysulfone, polyurethane, polyimide, and polyvinyl backbones.

11. The polymeric reagent according to claim 1 wherein the polymeric backbone is formed from monomeric units having ethylenically unsaturated groups.

12. The polymeric reagent according to claim 1 wherein the polymeric backbone comprises methacrylamide, acrylamide, or vinylpyrrolidone monomeric units.

13. The polymeric reagent according to claim 12 wherein the polymeric backbone comprises methacrylamide.

14. A method for making a modified surface, the method comprising steps of:
a. providing a polymeric reagent composition, the polymeric reagent composition comprising a polymeric backbone, latent reactive groups bound to the polymeric backbone, and melamine groups bound to the polymeric backbone, to a surface, and
b. binding the polymeric reagent to the surface.

15. The method according to claim 14 further comprising the step of halogenating the melamine groups with a halogen.

16. The method according to claim 14 wherein the providing step comprises providing a polymeric reagent comprising a polymeric backbone selected from polyester, polycarbonate, polyamide, polyether, polysulfone, polyurethane, polyimide, and polyvinyl backbones.

17. The method according to claim 14 wherein the providing step comprises providing a polymeric reagent comprising a polymeric backbone formed from monomeric units having ethylenically unsaturated groups.

18. The method according to claim 14 wherein the providing step comprises providing a polymeric backbone that comprises methacrylamide, acrylamide, or vinylpyrrolidone monomeric units.

19. The method according to claim 18 wherein the providing step comprises providing a polymeric reagent wherein the polymeric backbone comprises methacrylamide.

20. The method according to claim 14 wherein the providing step comprises providing a polymeric reagent wherein the latent reactive groups comprise photoreactive groups.

21. The method according to claim 20 wherein the providing step comprises providing a polymeric reagent comprising aryl ketones.

22. The method according to claim 21 wherein the providing step comprises providing a polymeric reagent comprising aryl ketones selected from acetophenone, benzophenone, anthraquinone, anthrone, and anthrone-like heterocycles.

23. The method according to claim 20 wherein the binding step comprises providing energy of a suitable wavelength.

24. The method according to claim 14 wherein the providing step comprises providing a polymeric reagent wherein the latent reactive groups comprise thermally-reactive groups.

25. The method according the claim 24 wherein the providing step comprises providing a polymeric reagent wherein the thermally-reactive groups comprise a peroxide group.

26. The method according to claim 25 wherein the providing step comprises providing a polymeric reagent wherein the thermally-reactive group comprises a peroxyester group.

27. The method according to claim 26 wherein the providing step comprises providing a polymeric reagent wherein the thermally-reactive group comprises a group selected from benzyl, diphenylacetyl, phenylacetyl, benzoyl, phenylbenzyl, hydrocinnamoyl, mandelyl, phenacyl, phenethyl, thiophenacyl, triphenylmethyl, biphenylacetyl, biphenylethyl, or biphenylmethyl.

28. The method according to claim 24 wherein the binding step comprises providing heat to the surface in a temperature sufficient to bind the polymeric reagent to the surface.

29. The method according to claim 14 wherein the surface is provided in a form of medical water supply lines.

30. The method according to claim 29 wherein the surface comprises a material selected from polystyrene, polyvinyl chloride, polyurethane, silicon, polypropylene, polyethylene, and metal.

31. The method according to claim 15 wherein the halogenating step comprises contacting the polymeric reagent composition with sodium hypochlorite.

32. A polymer-coupled support comprising:
a. a polymeric reagent composition of a formula
Xₐ—Y—Z_{b}
wherein X is a latent reactive group, Y is a polymeric backbone, and Z is a melamine group; and
b. a support, wherein the polymeric reagent is bound to the support.

33. The polymer-coupled support according to claim 32 wherein the latent reactive group is a photoreactive group.

34. The polymer-coupled support according to claim 33 wherein the photoreactive group is a photoreactive aryl ketone.

35. The polymer-coupled support according to claim 32 wherein the latent reactive group is a thermally-reactive group.

36. The polymeric reagent according to claim 35 wherein the thermally-reactive group comprises a peroxide group.

37. A halamine-modified surface comprising a polymeric reagent composition bound to a surface, the polymeric reagent having a formula
Xₐ—Y-Z_{b},
wherein X is a latent reactive group that is selected to bind the polymeric reagent to the surface, Y is a polymeric backbone, and Z is melamine containing halogen atoms at one or more amine groups pendent from the melamine.

38. A method for treating a habitat for halogen-sensitive microorganisms comprising contacting the habitat with an antimicrobial amount of a polymeric reagent having a formula
Xₐ—Y-Z_{b},
wherein X is a latent reactive group that is selected to bind the polymeric reagent to a surface within the habitat, Y is a polymeric backbone, and Z is melamine containing halogen atoms at one or more amine groups pendent from the melamine.

39. The method according to claim 38 further comprising providing a source of free halogen to the polymeric reagent on a periodic basis.

40. The method according to claim 38 wherein the microorganisms are selected from bacteria, fungi, molds, protozoa, viruses, and algae.

41. A monomeric unit having the formula: 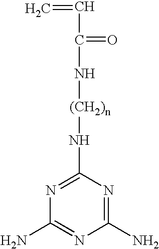
wherein n is 2 to 4.
